(19) United States
(12) Patent Application Publication
(10) Pub. No.: US 2006/0226619 A1
(43) Pub. Date: Oct. 12, 2006

(54) Dual position handle assembly for wheeled luggage

(76) Inventor: Bernard D. Sadow, Chappaqua, NY (US)

Correspondence Address: ABELMAN, FRAYNE & SCHWAB, 666 THIRD AVENUE, 10TH FLOOR, NEW YORK, NY, 10017, US

(21) Appl. No.: 11/192,671

(22) Filed: Jul. 29, 2005

Related U.S. Application Data
(60) Provisional application No. 60/670,568, filed on Apr. 11, 2005.

(51) Int. Cl. B62B 1/00

(52) U.S. Cl. 280/47.26

(57) ABSTRACT

An assembly comprising a carrying case and a rolling luggage cart, the carrying case includes an integral engagement means for releasably retaining the cart in at least two alternative towing positions that are displaced substantially orthogonally to each other relative to the case.

### CROSS REFERENCE TO RELATED APPLICATION

This patent application claims the benefit of U.S. Provisional Application Ser. No. 60/670,568, filed Apr. 11, 2005, the contents of which are incorporated by reference herein.

### FIELD OF INVENTION

The present invention relates to portable luggage, computer carrying cases, brief cases and similar items of luggage. More specifically, the present invention relates to a handle assembly and wheeled luggage system to facilitate towing of such luggage and cases.

### BACKGROUND OF THE INVENTION

The increase of human travel has created the need for the development of manually portable containers, such as luggage, carrying cases, brief cases, laptop computer cases, as well as other similar types of cases that enable the user to more easily transport their contents between destinations. The luggage or case must protect the contents while also reducing the burdens on the person transporting, e.g., pulling, pushing, or generally “towing” the luggage.

For example, U.S. Pat. Nos. 6,595,334 and 6,298,964 disclose luggage cart assemblies comprising a carrying case and a luggage cart. The cart has a handle with a handgrip coupled to a base and a plurality of wheels attached to the bottom of the base to enable rolling of the luggage assembly. In particular, the carrying case is attached to (e.g., seated on) the cart to enable the user to roll the luggage cart assembly with the case by pulling or towing the cart's handle.

Typically, articles of luggage or carrying cases have asymmetrical major dimensions, i.e. a different sized height and width. For those articles of luggage where a side being of a greater dimension than another side is positioned on the base of the cart for towing (i.e., horizontal to the ground), there can be instances where the size of the luggage is impeded when the user is traversing though a narrow pathway.

For example, when a user is towing the luggage down the aisle of an aircraft, the position of the luggage on the cart can be too wide to fit between the opposing seats forming the aisle. In such instances, the user is forced to either turn the luggage/cart assembly sideways and painstakingly drag it down the aisle, or lift and carry the sometimes heavy and bulky luggage down the aisle. Such inability to pass through the narrow pathway unimpeded is typically deemed inconvenient to the user, and also raises safety concerns.

For example, the user can have to inconveniently lift and carry the luggage for a time along the length of a narrow path, as well risk injury to the user and/or others by the actual lifting and carrying process, bumping into others, among other inconvenient and safety risk concerns. Currently, there are no luggage/carrying case assembly that enables a quick, on-the-fly, reconfiguration of the luggage assembly into a more convenient and/or safer mode for transport. Therefore, there is a need in the art for a wheeled luggage/carrying case assembly that provides user-friendly reconfiguration to allow convenient and safe transport, for example, though a narrow corridor or aisle.

### SUMMARY OF THE INVENTION

The disadvantages heretofore associated with the prior art are overcome by the present invention of a luggage assembly comprising a carrying case and a rolling luggage cart. In one embodiment, the carrying case having two different dimensions is provided with an integral engagement means for releasably retaining the cart in at least two alternative towing positions that are displaced substantially orthogonal to each other relative to the case.

In one embodiment, the engagement means comprises a stationary member secured to a wall of the case and a rotatable member that is received for rotation in the stationary member. The rotatable member is configured to retain a handle portion of the cart, whereby the cart and rotatable member are adjustable between first and second positions.

In another embodiment, the engagement means comprises a planar member secured exterior of a major sidewall of the case to form two intersecting channels for receiving the handle portion of the cart. The case is supported for towing with either of its two major dimensions transverse to the handle portion.

In a further embodiment, a clip and clip engagement member is utilized to retain the carrying case in position on the luggage cart. In one preferred embodiment, the clip is mounted for movement on the towing handle assembly and the luggage is provided with the clip engagement or receiving member which can be in the form of a rigid bracket, a strip of fabric that is permanently attached to an exterior wall of the carrying case, or a grommeted orifice that extends through a wall of the case. The size and thickness or opening dimensions of the receiving member are adapted to receive the clip in a secure, but manually releasable engagement.

The engagement system of this embodiment can be used with luggage carts having a towing handle assembly with one or a pair of legs. The clip can be attached to, or integrally formed, as by molding, in a movable cross-bar that extends between the pair of legs of the towing handle assembly; or the clip can be slidably mounted on the single leg, or on one or both legs of a dual-legged handle assembly. Where the clip is to be slidably mounted on a leg rather than a cross-bar, the clip can advantageously depend from a molded plastic collar that is formed to closely fit on the section of the leg upon which it is to slide longitudinally to engage the receiving element on the case. In a particularly preferred embodiment, the close-fitting collar can be easily moved into engagement with the case, but requires manual flexing to slide the clip up the leg away from the case.

In the embodiment where the clip extends from a crossbar, a sliding frictional fit between the close fitting ends of the crossbar and the supporting legs can be employed. Alternatively, manually releasable biasing means can be used to secure the clip in position on the leg or legs once it has been engaged with the case.

The present invention further includes a compactly foldable rolling luggage cart. The compactly foldable rolling luggage cart comprises a central housing, a handle assembly, and a leg assembly. The central housing includes an upper portion and a lower portion, and a centralized open channel extending longitudinally through the upper and lower portions.

The leg assembly includes a pair of retractable legs, each leg having a first end and a second end, include the first ends coupled to and extending from opposing sides of the lower portion of the housing. Each leg includes a respective luggage support member that is rotatably coupled to and extending from the second end. A wheel is respectively coupled to each second end, and each second end further includes an adapter for respectively retaining an end of an elastic strap proximate the wheel.

The handle assembly comprises a telescoping extension handle having a first end rotatably coupled within the channel of the housing, and a handgrip coupled to a second end of the extension handle. The handgrip includes a strap retaining member coupled to a rear portion of the handgrip, wherein the strap includes a clip coupled between the strap ends for removably attaching to the strap retaining member to mimimize excess slack in the strap when the cart is in a fully extended configuration for use and in the compactly folded configuration.

### BRIEF DESCRIPTION OF THE DRAWINGS

The present invention can be readily understood by considering the following detailed description in conjunction with the accompanying drawings, in which:

FIG. 1 depicts a perspective view of a first embodiment of an engagement member of a portable luggage assembly of the present invention;

FIG. 2 depicts a rear view of the first embodiment of the engagement member of the portable luggage assembly of FIG. 1;

FIG. 3 depicts a rear view of a second embodiment of the engagement member of the portable luggage assembly of FIG. 1;

FIG. 4 depicts a rear view of a fourth embodiment the engagement member of the portable luggage assembly of FIG. 1;

FIG. 5 depicts a perspective view of a second embodiment of an engagement member of a portable luggage assembly of the present invention;

FIGS. 6A-6B collectively depicts a third embodiment of an engagement member of a portable luggage assembly of the present invention;

FIGS. 7A-7C collectively depicts a fourth embodiment of an engagement member of a portable luggage assembly of the present invention;

FIG. 8 depicts a perspective view of a first embodiment of a luggage cart of the present invention suitable for use with the luggage assembly of FIG. 1; and

FIG. 9 depicts a perspective view of a second embodiment of a luggage cart of the present invention suitable for use with the luggage assembly of FIG. 1;

FIG. 10 is an exploded perspective view of one preferred embodiment of a wheeled cart and portions of a case illustrating the assembly of components comprising the engagement assembly and the interior of the bottom wall of a case;

FIG. 11 is a section view of the engagement assembly of FIG. 10 joined to the exterior wall of the case with a portion of the handle in position for engagement;

FIG. 12 is a view similar to FIG. 11 showing the handle secured (in phantom) to the engagement member where it can be rotated through ninety degrees;

FIG. 13 is a perspective view of a carrying case and a portion of a luggage cart illustrating another embodiment of mating engagement members of the invention;

FIGS. 14A and 14B illustrate an embodiment of a cart handle mounted clip of the invention;

FIGS. 15A and 15B illustrate another embodiment of the cart handle mounted clip of the invention;

FIG. 16 illustrates another embodiment that is similar to that of FIG. 13, but where the placement of the clip is reversed with respect to the handle assembly and carrying case;

FIG. 17 is a perspective view of a cart having a telescopic handle having a strap clip for retaining a strap when the cart is in a fully expanded state;

FIG. 18 is a side view of the cart of FIG. 17 illustrating the strap clip retaining the strap in the expanded state;

FIG. 19 is a bottom view of a leg and base member of the cart of FIG. 17 illustrating an adapter for securing an end of the strap; and

FIG. 20 is a perspective view of the cart of FIG. 17 illustrating the strap clip retaining a strap when the cart is in a fully closed state.

To facilitate understanding, the same reference numerals have been used, when appropriate, to designate identical or similar elements that are common to the figures. Furthermore, unless stated otherwise, the embodiments shown in the figures and discussed are not drawn to scale, but are shown for purposes of illustration only.

### DETAILED DESCRIPTION OF THE INVENTION

The present invention provides various embodiments to enable a user to adjust the position of the attachment of an article of luggage (e.g., a carrying case) in relation to a wheeled cart (e.g., hand cart or rack) for rolling the luggage, as by towing, or pushing. It is noted that the present invention is generally discussed in terms of a “carrying case,” such as a suitcase, attache case, computer case, duffle bag, briefcase, or any other article of luggage or container suitable for transporting personal items and contents by hand between points of destination.

In one embodiment of the invention, the carrying case includes an “engagement device” for releasably retaining the carrying case on the cart in at least two alternative positions. In one embodiment, the alternative positions are displaced approximately orthogonal, i.e., at a 90° angle, to each other. In one embodiment, the engagement device comprises a planar member attached to a rear portion or external wall of the carrying case. The planar member and rear portion form a plurality of openings there between to provide planar member channels that are sized to slidably receive a handle assembly of a portable luggage handcart. In this first embodiment, the user removes the cart from the carrying case in the first position and places the carrying case back on the cart in the second position.

In a second embodiment, the engagement device comprises a rotatable locking mechanism in which the user can rotate the carrying case without having to remove it from the cart. In a third embodiment of the invention, the portable carrying case cart can be reduced in size for improving user convenience during storage of the cart.

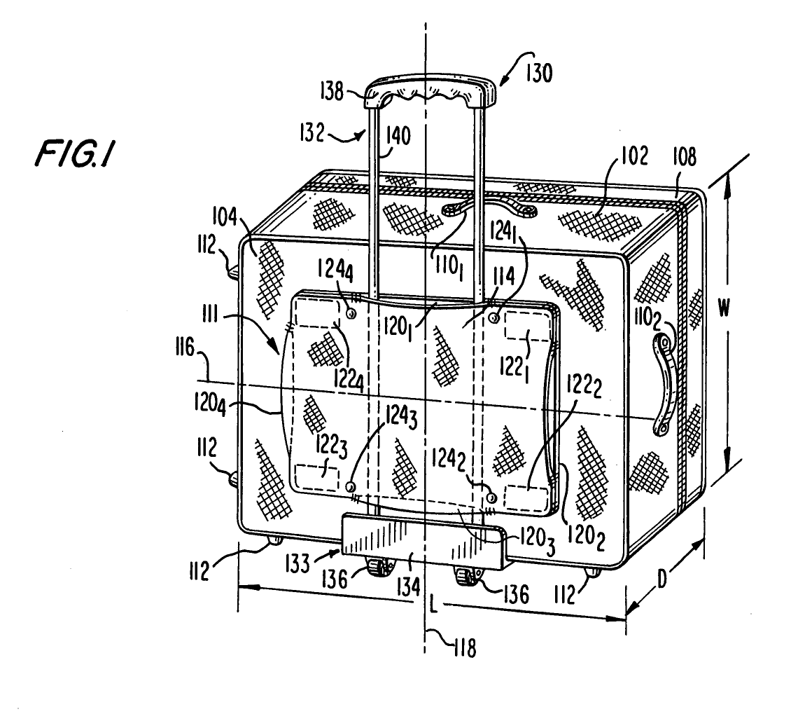

FIG. 1 depicts a perspective view of a first embodiment of an engagement member of a portable luggage assembly of the present invention. The luggage assembly 100 comprises a carrying case 102 and a luggage cart 130 suitable for receiving and transporting the carrying case 102 manually towing.

The carrying case 102 can be any type of carrying case, such as a computer carrying case, a suitcase, garment bag, briefcase, attache case, duffle bag, or any other container or article of luggage that is capable of transporting content by hand for a user. The carrying case 102 can be manufactured from any sturdy material such as plastic, leather, textile materials, metal, among other materials and/or a combination thereof, which is suitable for protectively transporting goods by hand, as conventionally known in the art.

As shown in FIG. 1, the exemplary carrying case 102 has a width W, height H, and depth D, where the width W and height H are referred to herein as the major dimensions and differing in length. Accordingly, the carrying case 102 shown in FIG. 1 is substantially rectangular, although such shape is not considered as being limiting. As discussed in further detail below, the present invention comprehends various embodiments of the luggage assembly 100 to provide benefits for a user traveling with a carrying case 102 that has external dimensions of differing height and width.

The carrying case 102 further comprises a rear portion 104 or external wall, at least one side wall 106, a front (e.g., cover) portion 108, at least one handle 110 (e.g., handles or handgrips 110₁ and 110₂), and an optional plurality of support members (e.g., feet) 112. In the exemplary embodiment shown in FIG. 1, a first handle 110₁ can be positioned on an outer surface of a top sidewall, illustratively shown along the width W of the carrying case 102. An optional second handle 110₂ can be positioned on an adjacent sidewall, illustratively shown along the height H of the carrying case 102.

Optionally, a first plurality of support members 112 is positioned on an outer surface of a sidewall opposing the first handle 110₁, notably the bottom of the carrying case 102. Further, a second plurality of support members 112 can also be positioned on an outer surface of a sidewall opposing the second handle 110₁, notably a side of the carrying case 102.

The luggage cart 130 can be any type of handcart conventionally known in the art that is suitable for securely transporting the carrying case 102 by towing. In FIG. 1, the cart 130 comprises a handle assembly 132 and a base assembly 133. The base assembly 133 comprises a base support member 134 having a plurality of rollers 136. The handle assembly 132 is coupled to an upper surface of the base member 134, and the wheels 136 are coupled to a bottom surface of the base 134. The rollers 136 can be any conventional rolling device, such as wheels, bearings, casters, among other rolling devices.

In one embodiment and as shown in FIG. 1, the handle assembly 132 comprises a handgrip 138 and at least one handle extension leg 140. A first end of the telescoping or extension leg 140 is coupled to the handgrip 138, while a second end of the extension leg 140 is coupled to the base 134. Although a pair of extension legs 140 are illustratively shown in FIG. 1, one of ordinary skill in the art will appreciate that a single or more than two extension legs 140 can be provided.

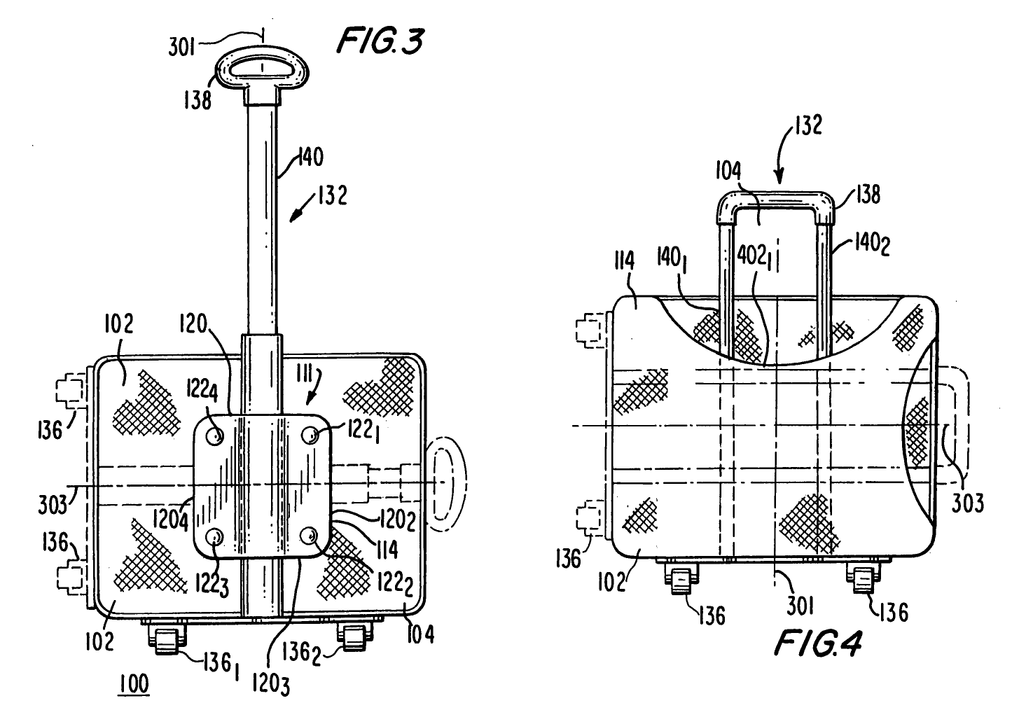

FIG. 3 depicts a rear view of a second embodiment of the engagement member 111 of the portable luggage assembly 100 of FIG. 1. Specifically, FIG. 3 illustrates a handle assembly 132 having a single telescoping leg 140. Note that FIG. 3 also shows the handle assembly in both possible positions along a first axis 301 and a second axis 303, where the handle assembly 132 is drawn in phantom along the second axis 303.

Accordingly, the luggage assembly 100 allows a user to place the bottom portion of the carrying case 102 on the upper surface of the base 134, with the rear portion 104 of the carrying case positioned adjacent the extension leg 140 of the handle assembly. In operation, when a user tilts the luggage assembly backwards, frictional forces retain the carrying case on the cart and the user pulls the handle to tow (i.e., roll) the carrying case to a destination.

The carrying case 102 further comprises an engagement member 111 formed at the rear portion 104 of the carrying case 102. In one embodiment, the engagement member 111 is formed by a planar member 114 coupled to the rear portion 104 of the carrying case 102, thereby forming at least one channel or sleeve there between. The engagement member 111 facilitates secure attachment of the carrying case 102 to the cart 130. The planar member 114 comprises a planer surface that is attached to an outer surface of the rear portion 104 of the carrying case 102. The planar member can be fabricated from any sturdy material resistant to tearing as conventionally known in the art, and can match or differ from the material used to fabricate the carrying case 102.

Although the planar member 114 is shown as being sized smaller than the rear portion 104 of the carrying case 102, one skilled in the art will appreciate that the planar member 114 can be any size suitable for securing the carrying case 102 to the handle assembly 132. For example, the planar member 114 can be of the same size as the rear portion 104 or a strap attached across the rear portion 104 of the case 102.

FIG. 4 depicts a rear view of a fourth embodiment of the engagement member 111 of the portable luggage assembly of FIG. 1. In this fourth embodiment, the planar member 114 is approximately the same size as the rear portion 104. Further, the at least one extension leg 140 is typically retractable to permit for better storage. That is, the extension leg(s) telescope from the base member 134 or a cross-member (not shown) of the cart 130.

In one embodiment, at least one recessed portion 402 is displaced inwardly from the edge of the planar member 114 to accommodate the handgrip 138 of the handle assembly 132 when in a retracted stowed position. As shown in FIG. 4, a first recessed portion 402₁ is provided at an edge of the planar member 114 opposite the bottom edge of the case 102 having the support members (feet) 112. Similarly, a second recessed portion 402₂ can be provided at an edge of the planar member 114 opposite the bottom edge of the case 102 having the support members (feet) 112. The first and second recessed portions 402₁ and 402₂ are substantially orthogonal to each other.

In one embodiment, the planar member 114 is substantially rectangular in shape and is attached at least at the edges (e.g., corners) 122 of the planar member 114 to the outer surface of the carrying case 102. The planar member 114 can be attached by stitching, heat bonding, adhesive bonding, chemical bonding, fasteners (e.g., rivet, mating snaps, and the like) or any other fastening device or mechanism that is suitable to secure the planar member 114 to the outer surface of the rear portion 104 of the carrying case 102.

As shown in FIG. 1, the planar member 114 is attached at the corners 122 of the planar member 114 to form a respective opening 120 between each corner 122. For example, a first opening 120₁ is formed between the first and second channel 122₁ and 122₂ where the planar member 114 is attached. Similarly, a second opening 120₂ is formed between the second and third corner 122₂ and 122₃ where the planar member 114 is attached, and so forth.

In one embodiment, a first pair of opposing openings 120₁ and 120₃ are formed along a central longitudinal axis 118 of the carrying case 102, while a second pair of opposing openings 120₂ and 120₄ are formed along a central horizontal axis 116 of the carrying case 102, each defining a passageway or channel for receiving the handle of the towing cart.

The luggage cart 130 can be manufactured and sold along with the carrying case 102 as a set. In this instance, the size of the openings 120 will be preformed to accommodate reception of a predetermined handle assembly 132. However, there can be instances where the carrying case 102 and cart 130 are sold separately, such that various types of carts can be used interchangeably with the carrying case 102. In this instance, the size of the handle assemblies 132 of the cart 130 can vary among models of each manufacturer, as well as between the manufactures themselves. As such, in one embodiment, the engagement device 111 can be adjusted to accommodate different sized handle assemblies 132 that can be purchased separately.

In particular, the planar member 114 can be attached at the corners 122 proximate the outer edge of the planar member 114, illustratively using rivets, stitching, and/or bonding, as discussed above. However, in one embodiment, the present invention allows a user to adjust the size of the openings 120 as needed to accommodate different sized handle assemblies 132. For example, as shown in FIG. 1 mating snaps 124₁-124₄ (collectively mating snaps 124) are illustratively utilized to reduce the size of the openings 120, as required to accommodate the cart's handle. The exemplary mating snaps 124 are positioned along the edge of the planar surface 114 between the corners 122, as well as between the outer surface of the rear portion 104 of the case 102 and the inner surface of the planar member 114.

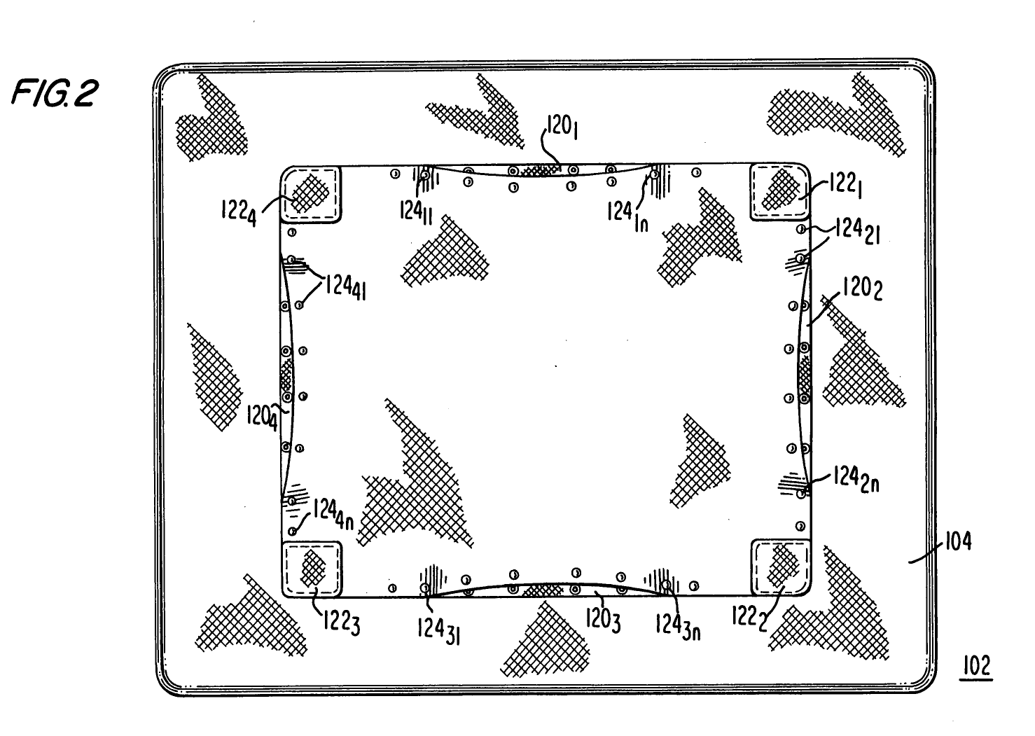

Although only a single snap 124 is shown in FIG. 1 proximate each extension leg 140 of the cart 130, one skilled in the art will appreciate that a series of mating snaps 124 can be positioned along the edge of the planar surface 114 between the corners to further reduce or expand the size of the opening 120, as illustratively shown below with respect to FIG. 2. It is also noted that the embodiment is not limited to the use of mating snaps, and that other fasteners (e.g., a zipper, hook-and-loop securements, or other non-permanent and user-adjustable fasteners can be utilized.

Referring again to FIG. 2, each opening 120₁ can have a plurality of mating snaps, fasteners, zippers, among other securing devices to adjust the size of opening 120 to accommodate the handle assembly 132. As discussed above with respect to FIG. 1, the corners 122 of the planar member 114 are attached to the rear portion 104 of the case, illustratively by stitching, bonding or a permanent fastener conventionally known in the art. Referring to FIG. 2, a series of fasteners (e.g., mating snaps) are provided between the permanent fasteners at the opposing corners 122. For example, user-adjustable fasteners 124₁₁ through 124₁ₙ, are positioned between corners 122₄ and 122₁, user-adjustable fasteners 124₂₁ through 124₂ₙ, are positioned between corners 122₁ and 122₂, user-adjustable fasteners 124₃₁ through 124₃ₙ, are positioned between corners 122₂ and 122₃, and so forth. The size and position of each opening 120 between the respective corners 122 is determined by fastening the user-adjustable fasteners (e.g., mating snaps 124). Thus, the user can adjust the size of the opposing openings 120 by adjusting the fasteners 124 to adjust the size of each opening 120 to receive and closely fit around the extension leg(s) 140 of the handle assembly 132.

During operation, the user stands the cart 130 in an upright position such that the handle assembly 132 is substantially vertical, and the base support member 134 is horizontal to the ground. The user ensures that the pair of opposing openings 120 formed between the rear portion 104 and planar member 114 is sized to accommodate the handgrip 138 of the cart 130. The user then lifts the carrying case 102 over the cart 130 and positions the rear portion of the carrying case 102 and planar member 114 over the handgrip 138 of the cart 130. Once the engagement member 111 is aligned over the handle assembly 132, the user lowers the carrying case 102 such that the handle assembly 132 slides between the inner surface of the planar member 114 and outer surface of the rear portion 104. The user continues to lower the carrying case 102 onto the cart 130 until the bottom portion of the case 102 is seated upon the base support member 134. Once seated, the user can adjust the size of the openings 120 to securely fit around the extension legs 140 of the handle assembly 132. For example, if there is only a single extension leg 140 associated with the handle assembly 132, then the user can close the non-permanent user-adjustable fasteners 124 on both sides of the opposing openings 120 to further reduce the size of the openings and secure the carrying case thereto the cart 130.

As noted above, the luggage assembly 100 can be too wide to fit through narrow corridors or pathways, such as an aisle between seats in an aircraft. That is, the user can have loaded the carrying case 102 on the cart 102 such that the widest side of the carrying case 102 is seated on the base member 134. It is noted that the user can have loaded the carrying case in this position to typically allow for storing a lighter second carrying case over the bulkier or heavier first carrying case 102. Once the user realizes that the cart assembly 100 does not have enough clearance to pass through the aisle between the seats, the user typically has had to turn the cart assembly 100 on its side and drag it through the aisle. Alternatively, the user can remove the carrying case 102 from the cart 130 and carry it separately, neither of which is convenient or a safe choice with respect to traveling.

The present invention overcomes these undesirable conditions by providing the second pair of openings (e.g., openings 120₂ and 120₄) substantially orthogonal to the first pair of openings (e.g., openings 120₁ and 120₃). As described above with respect to the first pair of openings 120₁ and 120₃ formed between the planar member 114 and rear portion 104, the second pair of openings 120₂ and 120₄ can be sized in a similar manner using non-permanent user-adjustable fasteners to accommodate the handle assembly 132 of the cart 130.

Referring to the first embodiment of FIG. 1, when a user is faced with a narrow corridor (e.g., an aisle on an aircraft or bus), the user will lift the carrying case 102 off the cart 130 by the first handle 110₁ of the carrying case 102, and then turn the carrying case approximately 90 degrees. Thereafter, the user can use the second handle 110₂ to lower the carrying case onto the hand cart 130, in a similar manner as described above. As such, the shorter side of the carrying case 102 is now seated on the base member 134 of the cart 130. The user can then safely tow (i.e., roll) the luggage assembly 100 through the narrow aisle without having to carry the carrying case 102 and cart 130 separately.

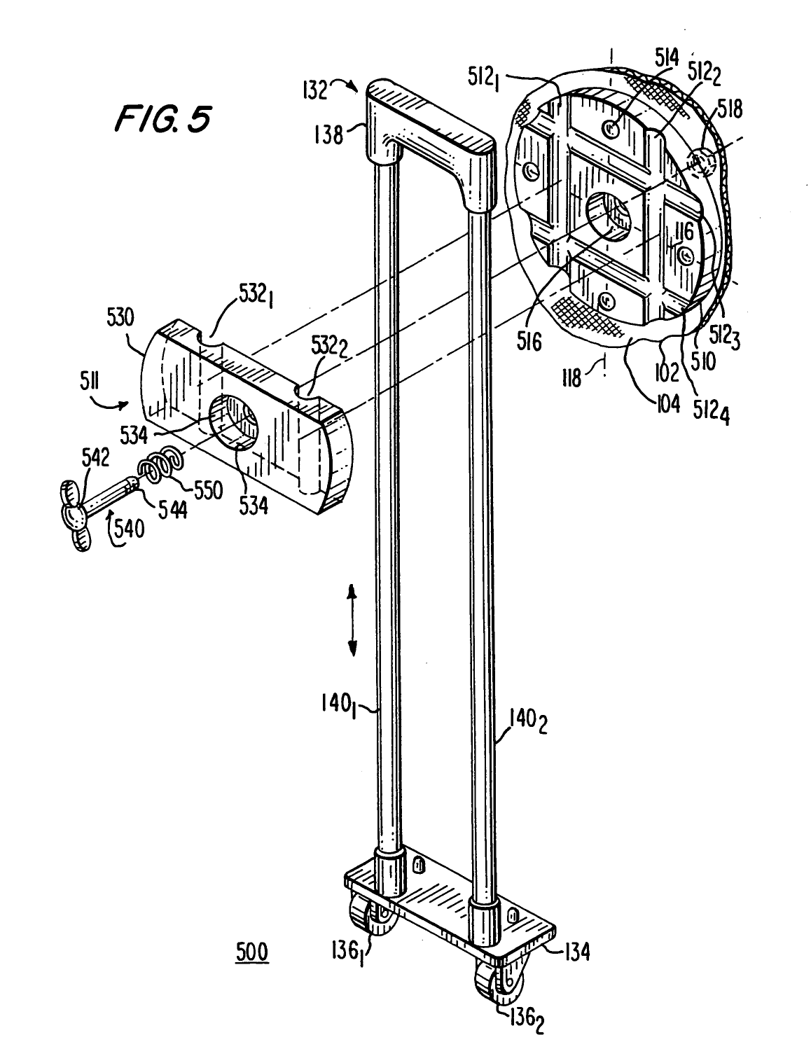

FIG. 5 depicts a perspective view of a second embodiment of an engagement member 511 of a portable luggage assembly 500 of the present invention. In particular, the second embodiment of the engagement member 511 comprises a stationary member 510, a rotatable member 530, and a fastener 540. As shown in FIG. 5, the stationary member 510 is coupled to the external surface of the rear portion 104 of the carrying case 102. In one embodiment, the stationary member 510 is positioned centrally on the rear portion 104, for example, by using a plurality of fasteners 514, such as rivets, bolts, snap fittings, or any other fastener capable of securing the stationary member 510 to the external surface of the rear portion 104 of the carrying case 102.

The stationary member 510 includes a plurality of grooves 512 and an opening 516. The plurality of grooves 512 are shaped to conform to the shape of the extension legs 140. In one embodiment, the grooves 512 are semi-circular in shape and are used to accommodate a frontal portion of the extension legs 140. As shown in FIG. 5, two extension legs 141 and 142 are illustratively utilized in the handle assembly 132. As such, a first pair of grooves 512₁ and 512₂ extends parallel along the longitudinal axis 118 of the case 102. Further, the first pair of grooves 512₁ and 512₂ are spaced a suitable distance to accommodate reception of the two extensions rods 140₁ and 140₂ of the cart 130.

Additionally, a second pair of grooves 512₃ and 512₄ is formed in the stationary member 510 perpendicular to the first pair of grooves 512₁ and 512₂. The second pair of grooves 512₃ and 512₄ are also spaced a distance suitable for accommodating the two extensions rods 140₁ and 140₂ of the handle assembly 132.

In one embodiment, the opening 516 is formed at the center of the stationary member 510 and is sized to receive the fastener 540. Further, in one embodiment the opening 516 can be threaded for receiving a threaded fastener 540.

Alternatively, the opening 516 can be unthreaded and aligned with a second opening (not shown) formed in the rear portion 504 of the carrying case 102. A corresponding second fastener with appropriate reinforcement 518 is provided at the internal wall of the rear portion 104 for coupling to the fastener 540.

The rotatable member 530 comprises a pair of semi-circular grooves 532₁ and 532₂ and an opening 534. The pair of grooves 532₁ and 532₂ are spaced a distance to receive a portion of the extension legs 140₁ and 140₂ of the handle assembly 132. In one embodiment the opening 534 is centrally located in the rotatable member 530 and is sized to receive the fastener 540.

In operation, the rear portion 104 of the carrying case 102 is placed against the extension legs 140 of the handle assembly 132 such that the first pair of grooves 512₁ and 512₂ circumscribe a front portion of the extension legs 140₁ and 140₂. The rotatable member 530 is positioned over the stationary member 510 such that the pair of grooves 532₁ and 532₂ circumscribes the rear portion of the extension legs 140₁ and 140₂. As such, groove 512₁ and 532₁ form a first channel and circumscribe the first extension leg 140₁, while the groove 512₂ and 532₂ form a channel to circumscribe the second extension leg 140₂. Fastener 540 is inserted through the rotatable member 530 and stationary member 510 to secure the rotatable member 530 to the stationary member 510 on the rear portion 104 of the carrying case 102.

In one embodiment, the fastener 540 comprises a bolt and a spring 550 where the bolt has a head portion 540 that is larger than the size of the opening 534, and the bolt is threaded to engage the threaded opening 516 of the stationary member 510. In a second embodiment, the threaded bolt can extend a distance through the stationary member 510 and the rear portion 104 of the carrying case 102 and is secured by a locking nut or a pin (e.g., a cotter pin) 518 on an internal surface of the rear portion 104. Spring 550 can be utilized to engage and disengage the rotatable member 530. In particular, bolt 540 passes through the coiled spring 550 such that the coiled spring 550 is positioned between the bolt head 542 and an inner surface of the opening 534.

For convenience of the user, the bolt head can include a wing style bolt head, which allows the user to grasp and turn the bolt. The shaft of the bolt 540 passes through coil spring 550, such that a first end of the coil spring is positioned between the bolt head 542 and a second end is positioned at the rotatable member 530. In one embodiment, a lip 534 is formed around the opening 534 to receive and support the second end of the coil spring 550.

The bolt 540 can be threaded into the opening 516 (or lock nut 518) of the stationary member 510 a distance that locks the rotatable member 530 against the stationary member 510. In this instance, the bolt head 542 is tightened to a point where the spring 550 is compressed and the bolt head contacts the rotatable member 530, thereby securing the carrying case 102 to the extension legs 140 of the cart 130.

When the user desires to rotate the carrying case 102 with respect to the cart 130, at least two techniques can be utilized. Initially, the user will loosen the bolt 540 a distance that allows the extension legs 140 to clear the channels formed by the grooves. For example, if the extension legs 140 of the cart 130 are aligned with the first pair of grooves 512₁ and 512₂ of the stationary member 510, and the grooves 532 of the rotatable member 530, then the bolt 540 must be loosened a distance to allow the extension legs 140 to be pulled apart from the stationary member 510. In this embodiment, coil spring 550 exerts an outward force such that the rotatable member 130 remains substantially in contact with the rear portions of the extension legs 140.

In order to rotate the carrying case 102, the user may need to slide the carrying case 102 upward a distance and away from the base support member 134 of the cart 130. Sliding the carrying case away from the base support member 134 allows for the corners of the case 102 to clear the base member 134 when subsequently rotating the cart 130 with respect to the case 102.

Once the fastener 540 has been untightened and the user has moved (e.g., slid) the case 102 a distance that is great enough for the corners to clear the base 134, the user rotates the cart 130 with respect to the case 102. One skilled in the art will appreciate that, alternatively, the case can be rotated with respect to the cart, or a combination of both actions can be performed. In any of the techniques to change the positioning between case and cart, once the cart 130 has been rotated approximately 90 degrees with respect to the carrying case 102, the user tightens the fastener 540 to secure the cart 130 in the second position with respect to the carrying case 102. Accordingly, the second embodiment of the engagement member 511 allows a user to rotate the carrying case 102 approximately ninety degrees with respect to the extension legs 140 of the cart 130.

FIG. 10 is an exploded perspective view of one preferred embodiment of a wheeled cart and portions of a case illustrating the assembly of components comprising the engagement assembly and the interior of the bottom wall of a case. The embodiment of FIG. 10 is similar to the embodiment shown in FIG. 5, except that the cart 130 has dual telescopic legs 140 and a cross-bar 920 disposed therebetween. The cross-bar 920 is positioned between the base 134 and the handle 138. Further, the bolt 540 used to secure the rotatable member 530 to the stationary member 510 does not include a wing style bolt head 542, as illustratively shown in FIG. 5. Rather, a hand grip or handle 552 is coupled to the rotatable member 530 by one or more fasteners (not shown); such as by screws, bolts, or other conventional fasteners, or can be unitary with the rotatable member 530.

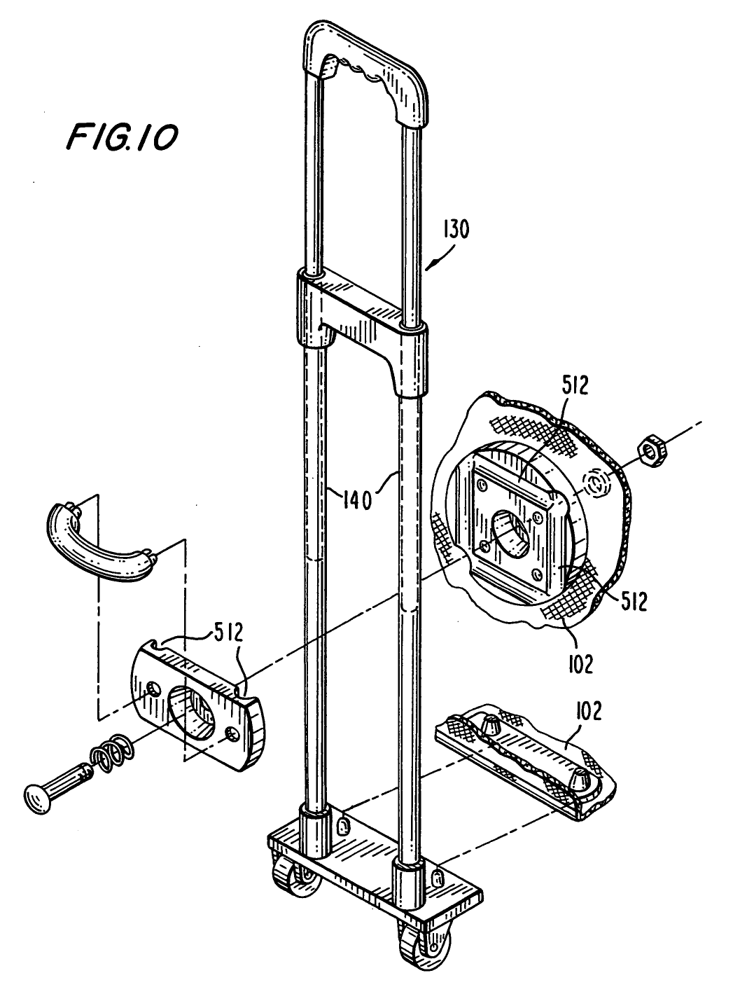

FIG. 11 is a section view of the engagement assembly of FIG. 10 joined to the exterior wall of the case with a portion of the handle in position for engagement. The rotatable member 512 is shown rotated orthogonal from the position shown in FIG. 10, and enables the cart 130 to be separated and pulled away from the case 102. Specifically, the user pulls the handle 552 of the rotatable member 530 outward away from the case 102 to allow the legs 140 to disengage the first pair of grooves (e.g., grooves 512₁ and 512₂ of FIG. 5) from circumscribing the legs 140 of the cart 130.

The cart 130 can be placed adjacent to the stationary member 510 and aligned within grooves 512₃ and 512₄. Once aligned in the grooves 512, the rotatable member 530 is pulled outward away from the case 102, rotated ninety degrees, and released to secure the dual legs 140 between the rotatable member 530 and stationary member 510. It is noted that spring 550 automatically pulls the rotatable member 530 towards the stationary member 510 when the user releases the handle 552.

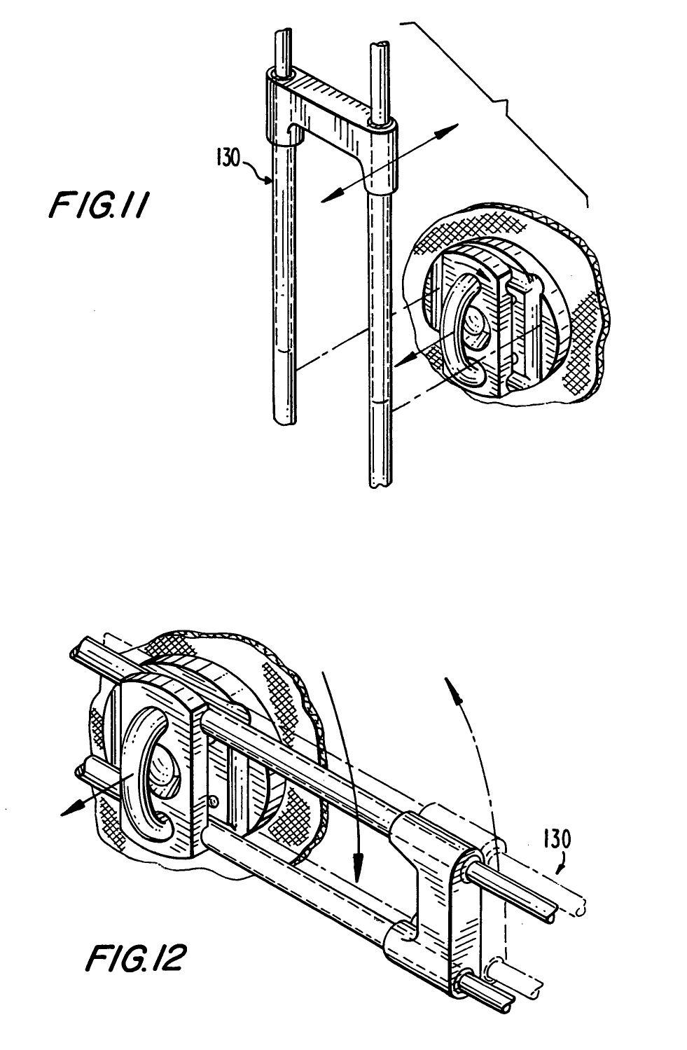

Referring to FIG. 12, alternatively, the user does not have to completely separate the cart 130 from the case 102 to rotate the cart 130 ninety degrees from its first secured position 1202 (drawn in phantom in FIG. 12). Rather, the user can pull the rotatable member 530 outward and away from the case, such that the legs 140 clear the grooves 512 of the stationary member 510 at second position 1204. As the user rotates the cart 135 ninety degrees, the grooves 532 of the rotatable member 530 retain the legs 140 of the cart 130 to the rotatable member 530, thereby preventing slippage. Once the cart is rotated ninety degrees, the handle 552 is released, and the rotatable member 530 secures the legs 140 of the cart 130 to the stationary member 510.

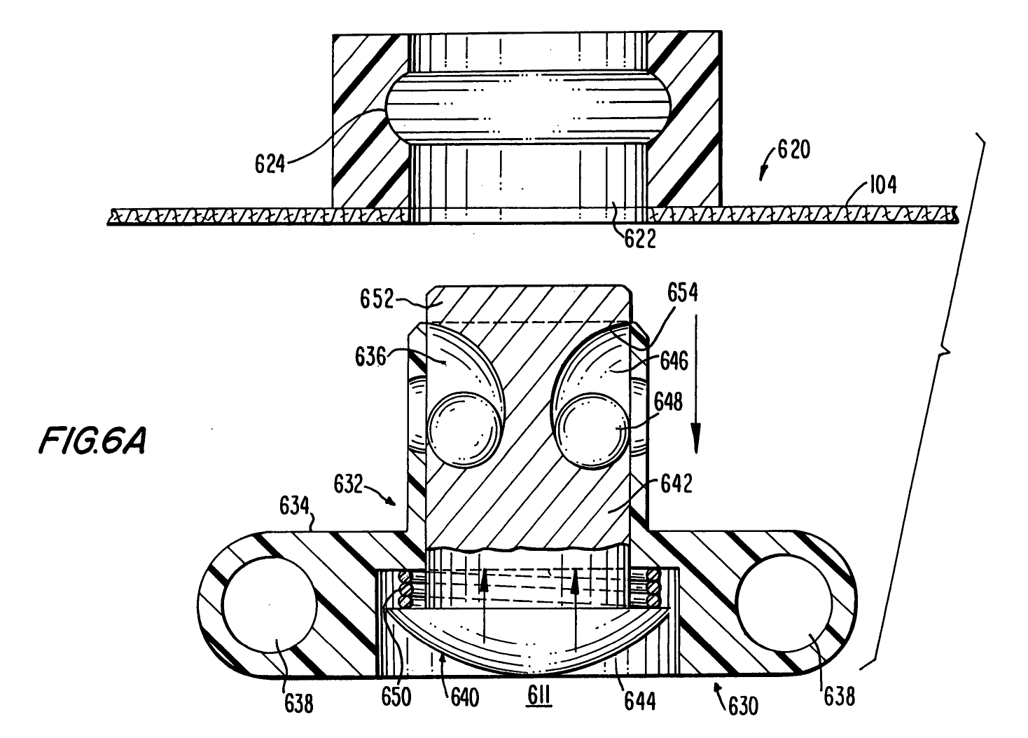

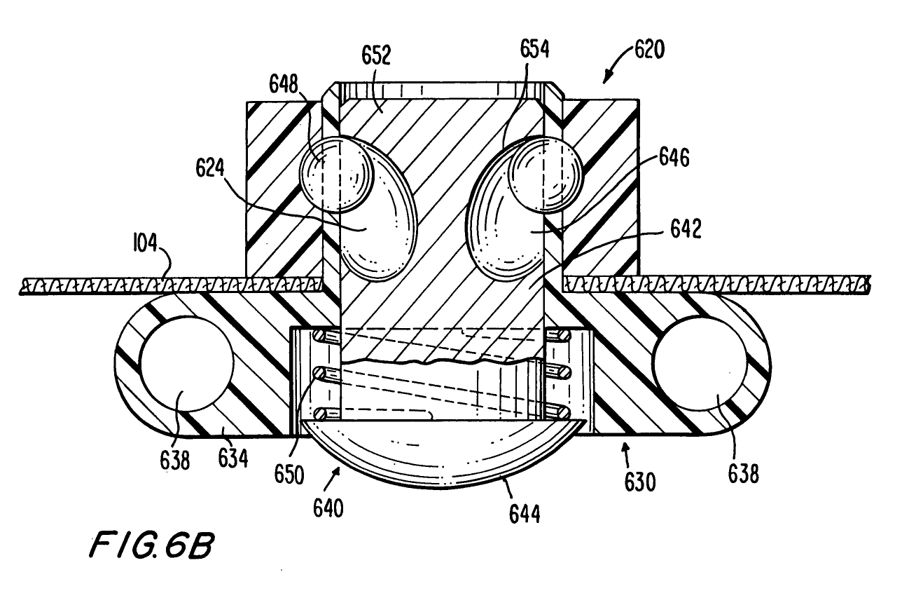

FIGS. 6A-6B collectively depicts a third embodiment of an engagement member 611 of a portable luggage assembly 100 of the present invention. The exemplary third embodiment of the engagement member 611 comprises a ball and socket relationship, where FIG. 6A illustrates a male connector portion 630 disengaged from a socket connector portion 620 and FIG. 6B illustrates the male and socket portions 630 and 620 while engaged.

In one embodiment, one of the connector portions (e.g., the socket connector portion 620) is attached to the carrying case, while the associated connector portion (e.g., the male connector portion 630) is attached to the handle assembly 130. For example, referring to the embodiment shown in FIG. 5, the socket connector 620 can be attached to a centrally located position on the external surface of the rear portion 104 of the carrying case. Further, the male connector portion 630 can be attached to the handle assembly 132. Where a single extension leg is utilized, the male connector 630 can be directly attached to the extension leg 140. Where multiple extension legs 140 are utilized, a cross-member (not shown) can be disposed between the extension legs 140₁ and 140₂ to facilitate attachment of the male connector portion 630.

In one embodiment, the male connector 630 comprises a housing 632 and a plunger (e.g., button) 640. The housing 632 can be cylindrical in shape having a flange 634 extending from one end of the cylindrical portion of the housing 632. The cylindrical portion of the housing comprises an opening 636 sized to receive the plunger 640. The flange 634 can include at least one opening 138 for permitting a fastener (not shown) to secure the housing 632 to the handle assembly 132 or rear portion 104 of the case 102, as required.

The plunger 640 includes a shaft 642 and a plunger head 644 having a diameter greater than the diameter of the shaft 642. The shaft 642 further comprises a shaft groove 646 sized to receive at least one bearing 648, such as a ball bearing. In one embodiment, the shaft groove 646 is sized larger than the bearing 648 to permit movement therein. The plunger shaft 642 extends a distance greater than the length of the cylindrical housing. The shaft groove 646 is formed between the inner walls of the cylindrical housing and the shaft 642. A bottom portion 652 of the shaft 642 extends outward towards the inner wall of the cylindrical housing and forms a portion of the shaft groove 646. A lower portion of the shaft groove 636 includes a tapered portion 654 that extends outward proximate the bottom portion 652 of the shaft.

The shaft 644 extends through a coil spring 650 proximate the flange 634 of the housing and the plunger head 644. The coil spring 650 has a diameter greater than the opening 636, but less than the diameter of the shaft head 644.

The socket connector portion 620 is also cylindrical in shape and includes an opening 622 and a socket groove 624 that extends into the internal sidewalls of the socket connector portion 620.

FIG. 6B illustrates the engagement member connector 611 at a position where the male connector portion 630 is inserted and secured in the socket connector portion 620. In particular, when the cylindrical housing and plunger are aligned over the socket opening 622, the user can push the male connector 630 into the socket connector 620 such that the bearing 648 is positioned between the socket groove 624 and the shaft groove 636. When the user pushes the plunger 642 of the male connector 630 inward, the coil spring 650 compresses. When the coil spring 650 is compressed, the bearing 648 remains in the non-tapered portion of the shaft groove 636 and the inner wall of the cylindrical housing.

Once the cylindrical housing and plunger shaft 642 are collectively inserted into the socket opening 622, the bearing 648 will roll between the socket groove 624 and the shaft groove 636. When the user releases the shaft head 644, the coil spring 650 expands between the shaft head 64 and flange 634. The expanding coil spring 650 pushes the shaft head 644 and shaft 642 outward and away from the socket connector 620, such that the tapered portion 654 of the shaft groove 636 secures (i.e., locks) the bearing 648 between shaft 642 and the socket groove 624. To release the male connector portion 630 from the socket connector portion 620, the user can push the plunger head 644 inward towards the socket connector 620. Depressing the plunger inward allows the bearing 648 to retreat from contacting the socket groove 624 and move (roll) up towards the non-tapered portion of the shaft groove 636, as the shaft 642 disengages from the socket connector 620.

Various other constructions and assemblies that are known in the art can be utilized to provide a manually activated release and/or alignment system. Biased assemblies can also be provided that are movable by application of an overriding force in lieu of a positive lock and release mechanism.

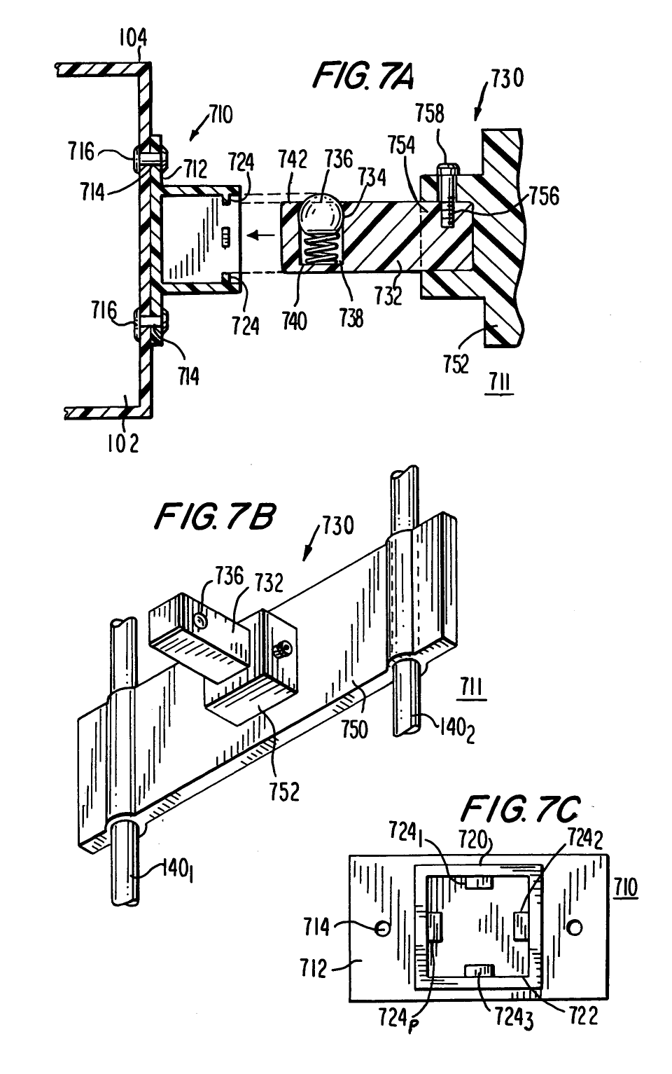

FIGS. 7A-7C collectively depicts a fourth embodiment of an engagement member 711 of a portable luggage assembly 100 of the present invention. Specifically, FIGS. 7A-7C illustrate a spring-loaded ball and socket arrangement, which can be utilized to engage and disengage the case 102 from the cart 130 to permit rotation of one with respect to the other. The engagement member 711 comprises a socket connector 710 and a shaft connector 730.

Referring to FIG. 7A, a socket connector 710 is coupled to the rear portion 104 of the carrying case 102. In one embodiment, the socket connector 710 includes a flange 712 circumscribing a first end for attachment to the rear portion 104. For example, the flange 712 can include one or more openings 714 sized to receive a fastener (e.g., rivet) to retain the flange 712 of the socket connector 710 flush against the rear portion 104 of the case. One skilled in the art will appreciate that other fasteners can be utilized, such as bonding agents and techniques, bolts, snaps, or other mechanical fastening devices.

The socket connector 710 extends outwardly a distance from the rear portion 104. The socket connector 710 comprises an outer wall 720 and an inner wall 722. The socket connector 710 can be any shape suitable for receiving the shaft connector 730. In FIG. 7A, the shape of the socket connector 710 is illustratively shown as being round and includes an inwardly protruding flange 724 extending inward from the inner sidewall 722. Alternatively, the socket connector 710 can be substantially square in shape, and include a plurality of inwardly protruding flanges 724₁ through 724ₚ (where p is an integer greater than one) on each inner sidewall 722, as illustratively shown in FIG. 7C.

The shaft connector 730 comprises a shaft 732 having a shape (e.g., round, square, octagon, among others) suitable for insertion into the socket connector 710. The shaft 732 includes a first end and a second end. As illustrated, the first end is adapted for being attached to the handle assembly 132 of the cart 130. As shown in FIG. 7B, the first end of the shaft 732 is coupled to a cross-member 750 positioned between the pair of extension legs 140₁ and 140₂. In one embodiment, the cross-member 750 includes an adapter 752 having a socket 754 sized to receive the first end of the shaft 732. In one embodiment, a fastener (e.g., a tap screw) 758 can be used to secure the first end of the shaft into the adapter socket 754. One skilled in the art will appreciate that other fastening devices can be utilized to attach the first end of the shaft 730 to the cross member 750.

The second end of the shaft 730 is utilized for insertion into the socket connector 710. In one embodiment, the second end of the shaft 730 includes at least one circular recess 734 for receiving a ball bearing 736. The circular recess 734 circumscribes the ball bearing over a surface area to retain the ball bearing 736 within the recess of the shaft 732. The recess 734 is slightly larger than the ball bearing 736 to permit inward and outward motion. In one embodiment, a bore 738 is formed proximate the bottom portion of the recess 734, where the bore 738 accommodates a coil spring 740. The bore 738 and coil spring 740 are perpendicular to the surface of the shaft 732. The coil spring 740 exerts an outward force on the ball bearing 736 to maintain the ball bearing 736 in a position extending above the surface area 742 of the shaft 732.

The recess 734 and ball bearing 736 are spaced a distance from the edge of the second end of the shaft 730. Further, the inward flange 724 is spaced a distance from the rear portion 104 of the case 102 to receive the second end of the shaft 732 and the ball bearing 736. That is, the distance between the end of the socket connector 710 coupled to the rear portion 104 and the inward flange 724 is sized to receive the second end of the shaft beginning at and including the recess 734 to the edge of the second end of the shaft 732. The diameter of the inward flange 724 is sized to receive the second end of the shaft 732.

In operation, as the user inserts the second end of the shaft 732 into the socket connector 710, the inward flange 724 exerts a force on the ball bearing 738, which forces the ball bearing 736 inward and compresses the spring 740. Once the ball bearing 736 is pushed past the inward flange 724, the spring 740 expands, thereby pushing the ball bearing in an outward direction to its normal position. The ball bearing 740 and inward flange 724 cooperate with each other to retain the second end of the shaft 732 in the socket connector 710. The shaft connector 730 thereby securely couples the cart 130 to the socket connector 710 attached to the carrying case 102.

To remove the handle assembly 132 of the cart from the rear portion of the case 102, the user exerts an outward force on the handle assembly 132 to pull the second end of the shaft 732 away from the socket connector 710. That is, while exerting the outward force, the inward flange 724 pushes the ball bearing 726 inward until the ball bearing is substantially flush with the outer surface of the shaft 732. Once the ball bearing 736 clears the inward flange 724, the spring 740 expands, and pushes the ball bearing 736 to its normal position protruding above the outer surface of the shaft 732.

One of ordinary skill in the art will appreciate that other ball-and-socket arrangements can be utilized to secure the cart 130 to the rear portion 104 of the case 102. For example, the ball bearing can be installed in the socket connector 710, while an outward extending flange is formed on the outer surface of the shaft. Alternatively, a button can be provided on the first end of the shaft to lock the ball bearing 724 in place to prevent any external force from disconnecting the second end of the shaft 732 from the socket connector 710, as conventionally known in the art. Moreover, the shaft connector 730 can be attached to the rear portion 104 of the case 102, while the socket connector 710 is coupled to the luggage cart 130.

Although FIGS. 5-7 illustratively show a handle assembly 132 comprising dual extension legs 140₁ and 140₂, a person skilled in the art will appreciate that a handle assembly 132 having a single extension leg can also be utilize a similar type engagement member 111 as shown in FIG. 5. In this instance, the stationary member 510 comprises a first groove 512₁ extending centrally along longitudinal axis 118, and a second groove 512₂ extending centrally along horizontal axis 116 to form a plus-sign (+) shaped groove formed along stationary member 510. Moreover, rotatable member 530 will also comprise a single groove down the center of the rotatable member to accommodate the rear portion of the single extension bar 140. In one embodiment, the openings 516, 534 and corresponding fastener 514 can be positioned off center through the stationary member 510 and rotatable member 530 to accommodate securing and releasing of the rotatable member 530 against the stationary member 510.

In either of the embodiments (single or multiple extension legs 140) shown or discussed with respect to FIGS. 5 and 6A-6B, once the user has rotated the carrying case 102 or cart 130, the user then slides the case 102 down until the bottom surface of the case 102 is seated upon the upper surface of the base member 134 of the cart 130. The user can retighten the fastener 540 and proceed to tow the case. Thus, a traveler who is confronted with a narrow passageway, such as an aisle between seats in an aircraft, can overcome the inconvenience and danger of sliding the luggage assembly sideways or having to lift and carry the luggage assembly. The traveler can simply utilize the engagement member of the present invention to change the positioning of the carrying case 102 substantially orthogonal relative the handcart 130.

It is noted that although the luggage assembly 100 is shown and discussed as having conventional wheels 136 on the cart 130, a person skilled in the art will appreciate that the various embodiments of the engagement member 111 are also suitable for use where the wheels or rollers are attached directly to the container (e.g., luggage). For example, with respect to the embodiments of FIGS. 1-4, the handle assembly 132 can be attached to a rear bottom portion of the case. When the user desires to rotate the position of the hand assembly 132 relative to the case, the user disengages the handle assembly 132 from the rear bottom portion and slidably removes the extension leg(s) and handle from between the rear portion 104 and planar member 114. Once removed, the user can reinsert the handle assembly 132 substantially orthogonal to the original position between the planar member 114 and rear portion 104 in a manner discussed above. Thereafter, the lower portion of the extension legs 140 are attached to the newly bottom rear portion of the carrying case 104.

One of ordinary skill in the art will also appreciate that the same teaching are applicable to the embodiment discussed and shown with respect to FIGS. 5-7. That is, the rollers 136 can be attached to two sides of the carrying case (e.g., luggage) as opposed to a base member 134 of a cart 130. Moreover, although the various embodiments of the engagement member have been shown and discussed with respect to FIGS. 1-7 in terms as being attached directly to the rear portion 104 of the case 102, a person skilled in the art will appreciate that a strap or panel can be attached to the rear portion of the case to facilitate coupling of the engagement member thereto.

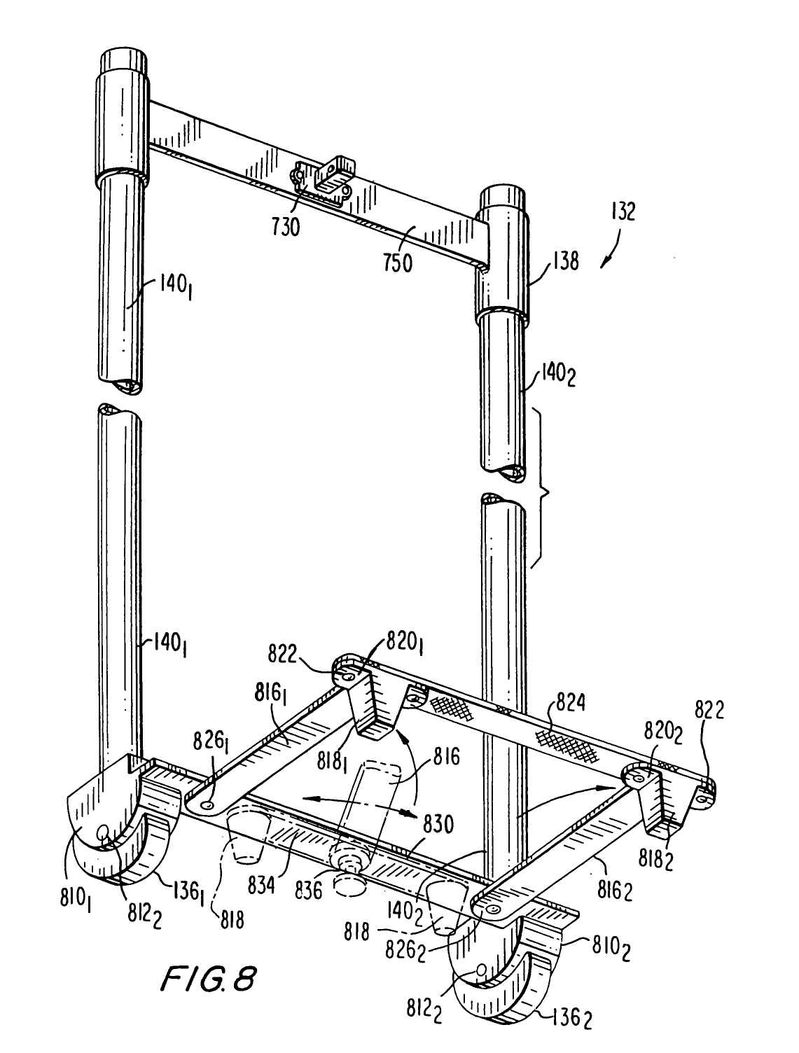

FIG. 8 depicts a perspective view of a first embodiment of a luggage cart 130 of the present invention. The luggage cart 130 comprises a handle assembly 132 coupled the base assembly 133, as described above with respect to FIG. 1. The base assembly 133 comprises the base member 134, wheels or rollers 136, and at least one lateral base member 816. As shown in FIG. 8, a pair of lateral members 816₁ and 816₂ extends lateral and outward in a direction opposite the handle assembly 132. The lateral members 816 are joined to the base member 134 to provide additional support to a bottom surface of the carrying case 102.

Although a pair of lateral base members 816 is shown, it will be understood that a single or plurality of lateral members 816 can be coupled to the base support member 134. For example, a single lateral member 816 can be coupled to a center portion of the base member 134. In any of the embodiments, the lateral members 816 are fabricated from a substantially non-flexible durable material, such as plastic, or metal.

In one embodiment, a first end of each of the pair of lateral members 816 is coupled to the base member 134 via a fastener (e.g., fasteners 826₁ and 826₂) that permits the lateral members 816 to be manually rotated towards the center of the base member 134, in a range of approximately ninety degrees. The fastener 826 can be a rivet, bolt, or other fastener capable of permitting rotation of the lateral members 816. As shown in FIG. 8, the lateral members 816 are fastened to a lower surface of the base member 134. However, the lateral members can also be fastened on the upper surface of the base member 134, or an adapter or extension (not shown) can be utilized to permit the upper surface of the lateral members 816 to be flush with the upper surface of the base member 134.

In one embodiment, a second end of each of the pair of lateral members 816 includes a foot support 818. Each foot 818 extends a distance from the bottom surface of the lateral member 816 to enable the cart to stand horizontal to a substantially level ground surface and in an upright position without tipping over. That is, rollers 136 and supporting feet 818 contact the ground surface when the cart 130 is in a non-tilted, upright position.

It is noted that in an instance where a single lateral member 816 is utilized, the lateral member can be attached to a slot 830 formed along the base member 134, which extends proximately a length between the extension legs 140 of the handle assembly 132. In this embodiment, the slot 830 (drawn in phantom) has a width sized to receive a fastener 836 (drawn in phantom), such as a bolt and wing nut or knob slot. As such, the single lateral member 816 can be rotated 180 degrees around the fastener 836.

When a user is carrying the case on the cart 130, the single lateral member 816 can be moved along the length of slot 830 to approximately the center of the slot 836 and extended perpendicular from the base member 134 to provide maximum support for the case 102. When the user wishes to store the cart after use, the user loosens the fastener 836 and slides the lateral member 816 in either direction towards the extension legs 140 and then rotates the lateral member to a position substantially parallel with the base member 134.

Other embodiments can include a single lateral member, such as exemplary lateral member 816₁ being attached to the base member 134 proximate the extension leg 140₁. In this embodiment, the fastener 826₁ permits the user to rotate the lateral member 816₁ approximately 45 degrees towards the center axis of the base member 134 to provide maximum support of the case 102.

Referring to the embodiment shown with respect to FIG. 8, at least one flexible support member 824 can be coupled between the pair of lateral supports 816. In particular, the flexible member 824 is fastened at a second end of each lateral member 816. For example, each lateral member 816 can include a flange 820 for facilitating fastening each end of the flexible member 824 with fasteners 822. The fasteners 822 can be any mechanical fastener or bonding device capable of securing the flexible member to the second ends of the lateral members 816.

In one embodiment, the flexible member 824 is fabricated from a flexible durable textile and forms as a strap between the second ends of the lateral members 816. For example, the flexible member 824 can be fabricated from cloth, plastics, nylon, or any other flexible material that will permit the lateral members 816 to be rotated with respect to the base member 134 with minimal impedance. The construction and assembly of such devices is well known to the art.

Accordingly, when a user wishes to store the cart 102, the pair of lateral members 816 are rotated towards the center of the base member 134, such that the flexible member 824 flexes (e.g., folds upward and/or downwards) with respect to the upper surface of the lateral member 816 and base member 134, and permits the lateral members 816 to be rotated to a position substantially parallel with the base member 134. Conversely, when the user wishes to use the cart 130 to carry the carrying case 102, the lateral members 816 are rotated perpendicular with respect to the base member 134, and the flexible member 824 expands outward and extends substantially level between the lateral members 816.

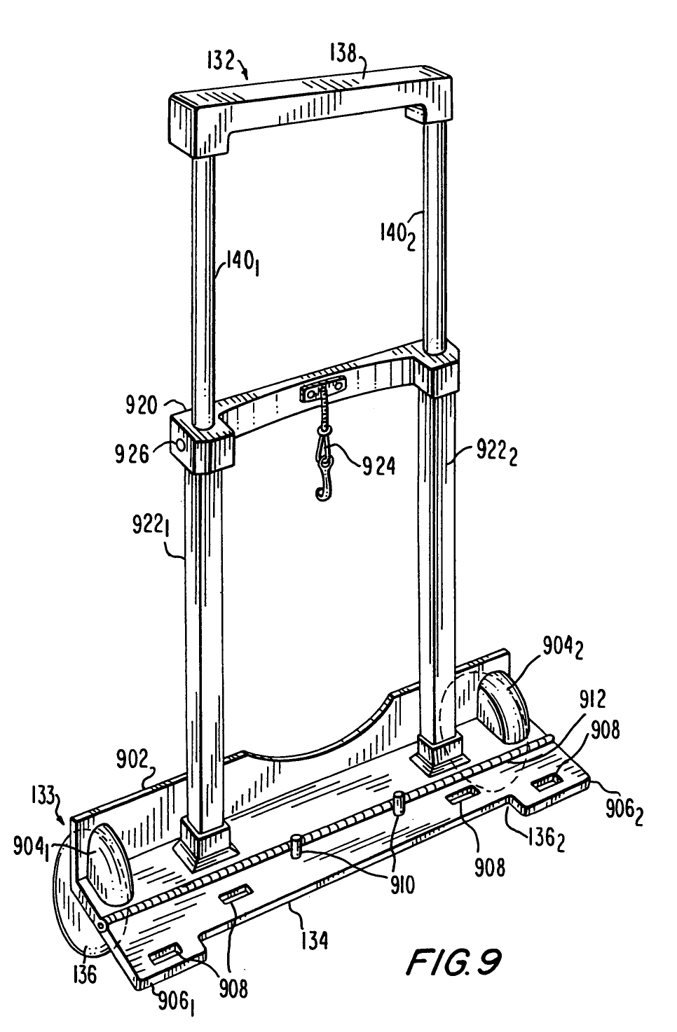

FIG. 9 depicts a perspective view of a second embodiment of a luggage cart 130 of the present invention suitable for use with the luggage assembly 100 of FIG. 1. The exemplary cart 130 comprises a handle assembly 132 coupled to a base assembly 133. In one embodiment, the base member 134 comprises wheel wells 904 on each end to protect the carrying case 102 from the cart wheels 136. In one embodiment, a back base plate 902 can be coupled to the base member 134 proximate the handle assembly 132 to provide additional support for the case 102.

In one embodiment, a plurality of base openings 908 can be formed in the base member 134. The base openings 908 are spaced and sized to receive the optional plurality of support members (e.g., feet) 112 provided on the outer surface of the case 102. Such base openings 908 can be provided along various portions of the base member 134 to accommodate varying sized cases (e.g., luggage).

In an alternative embodiment, at least one post 910 can extend perpendicular to the upper surface of the base member 134. The at least on post 910 is sized and positioned to be received by an associated at least one bore or slot (not shown) formed in the external surface of the carrying case 102. One skilled in the art will appreciate that the openings 908 should not be considered as being limiting, and other indentations, bores, and/or slots can be provided as required. In either embodiment, the openings 908/feet 112, posts 910/bores provide case-to-cart alignment and further stability for retaining the case 102 on the cart 130. One skilled in the art will appreciate that other fasteners, such as magnets, straps, mating snaps, hook-and-loop fasteners, among others can be used to position and retain the bottom sidewall of the case 102 on the upper surface of the base member 134.

In one embodiment, the base member 134 can be rotatable to allow the user to fold at least a portion of the base member 134 in an upward position substantially parallel to the handle assembly 132. As illustratively shown in FIG. 9, a hinge 912 can be provided to allow the user to fold the base member approximately 90 degrees or until it contacts the handle assembly 132 to further reduce the size of the cart 130 during storage.

In one embodiment, the handle assembly 132 is telescopic, and comprises at least one extension leg 922 for receiving the extension legs 140. In FIG. 9 illustratively depicts a pair of extension legs 922₁ and 922₂. A first end of each extension leg 922 is coupled to the base assembly 133. In one embodiment, the extension legs 922 are coupled to the upper surface of the base member 134. One skilled in the art will appreciate that the extension legs 922 can be coupled to the back base plate 902, among other suitable locations of the base assembly 133.

In one embodiment, a second end of the extension leg 922 is coupled to a cross-member 920. The extension legs 922 are hollow and sized to slidably receive a first end of the extension legs 140. The second end of the extension legs 140 are coupled to the handgrip 138. The user can manually push or pull the handgrip 138 up or down so that the telescoping legs 140 slidably move within the respective lower portions 922. A clip or locking mechanism 926 can be provided to retain the extension legs 140 at a desired height above the cross-member 920.

The cross-member 920 can include the engagement member (not shown in FIG. 9), such as the exemplary engagement members in connection with FIGS. 5-7. Further, for the embodiment shown in FIG. 4, a case handle retainer 924 can also be coupled to the cross-member 920. The case handle retainer 924 can be used to retain the top portion of the case against the handle assembly 132, as well as preventing the case 102 from lifting upward, for example, if the user goes over a bump. The case handle retainer 924 can be a fastener, such as a snap-swivel, a strap having mating snaps, or any other fastener capable of retaining the handle of the case.

It will also be understood that the relative positions of the clip and clip retaining or receiving member can be reversed, i.e., that the clip can be mounted on the carrying case. In this arrangement, the handle assembly is provided with sliding clip retainer for receiving the carrying case in the towing positions; or two separate clip retainers can be mounted on the leg or on the crossarms for receiving the clip when the case is mounted in each of the two alternative positions on the cart.

Referring now to FIG. 13, a carrying case 102 is shown with each of several different types of clip retaining components installed. It is to be understood that the inclusion of multiple types of clip retainers is for illustrative purposes only and to simplify the description of the invention and the number of drawings.

With continuing reference to FIG. 13, a metal or molded plastic clip-retaining element in the form of a bracket 170 extends from an upper portion of the rear wall 104 of case 102. The opposing bracket ends 172 are preferably positioned on the interior of the case for aesthetic reasons, but can also be attached by conventional fastening means to the exterior surface of wall 104. A bracket can be attached using one or more rivets 174, or even by stitching if the bracket is molded from a resilient polymer. Bracket ends 172 can advantageously be concealed behind a liner or other material inside the case.

As also illustratively shown in FIG. 13, a second clip retaining member 180 in the form of a flexible fabric web or strap is secured parallel to an orthogonal edge of case 102 to provide engagement means when the bag is rotated for movement down a narrow passageway. Again, opposing ends 182 can be attached by stitching and/or rivets 174, by adhesive bonding, or by other means well known in the art.

Also shown in FIG. 13 is the use of a pair of openings 190 that penetrate the narrow sidewalls of the case and are fitted with metal or polymer grommets 190. In a particularly preferred embodiment, a grommet is provided with a cover 192 and extending plug element 196 for closing the opening when it is not in use to thereby protect the contents of the case from the weather, dust, debris and other foreign matter. In a particularly preferred embodiment, a resealable closure 192 is integrally formed with a polymeric grommet 190, to which it is joined by a living hinge 194 or other flexible link. This construction allows the closure 192 to remain affixed to the case via the grommet and thereby eliminate the risk of loss.

Also shown in FIG. 13 is a representative crossarm assembly 138 that is slidably mounted on the parallel legs of a conventional luggage cart of the prior art. The crossarm 138 is provided with an integrally molded clip 165 that extends from the surface of arm 138 and is downwardly directed. When the case 102 is supported on the base of the luggage cart, the crossarm 138 is lowered until clip 165 engages any of the clip retaining components 170, 180 or 190. It is to be understood that the size, shape and specific configuration of clip 165 can be varied, the only limitation being that the clip securely engage the clip-receiving member that is formed as part of case 102. As will also be apparent to one of ordinary skill in the art, more than one clip can be secured to the crossarm and a corresponding number of clip retaining members can be provided on the case.

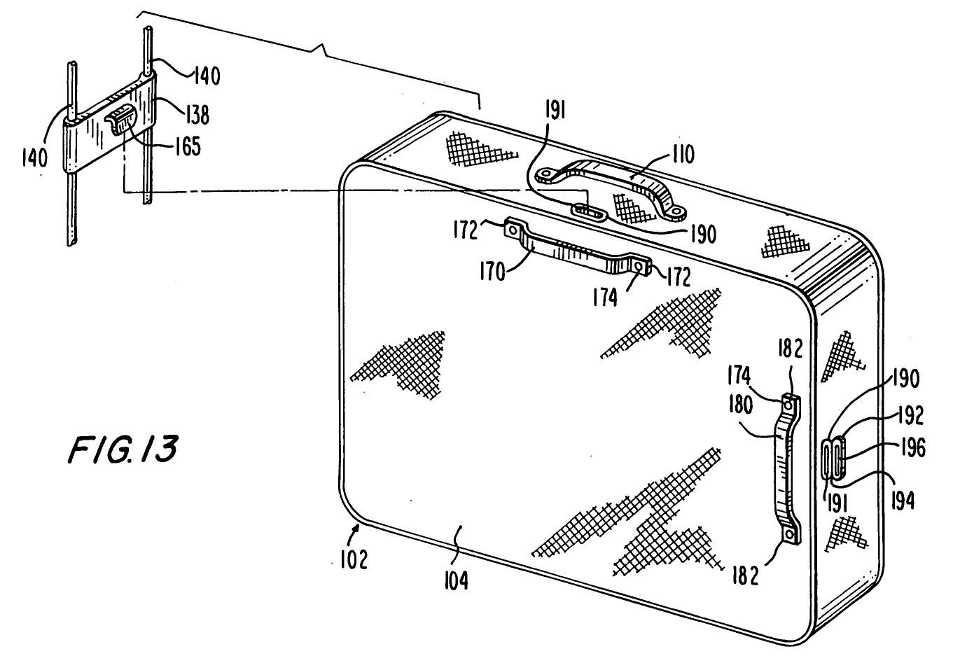

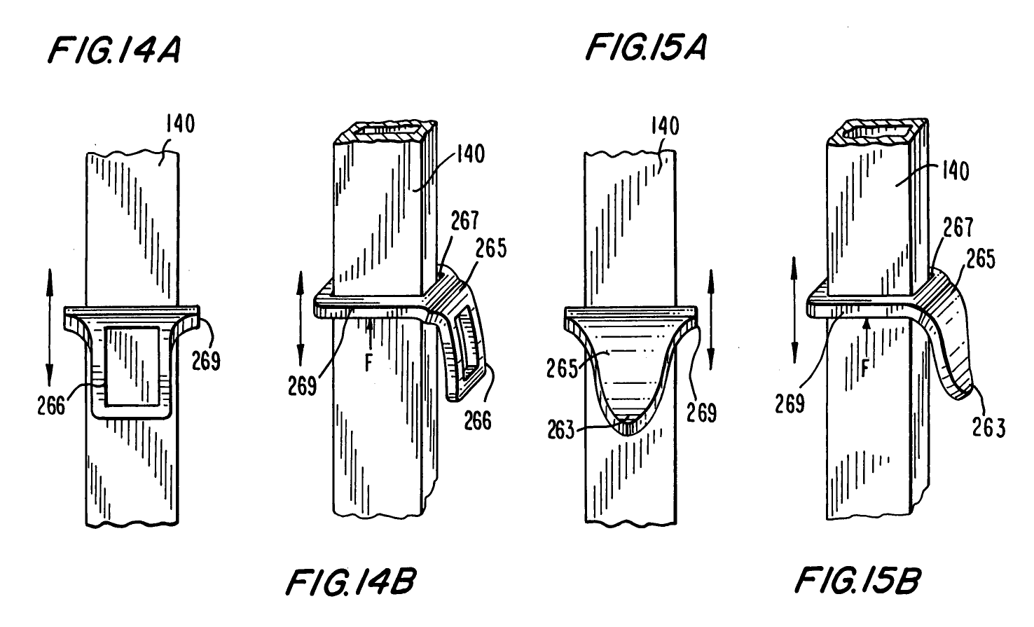

Referring to FIGS. 14A and 14B, another preferred embodiment of a clip and movable mounting means is shown. In this embodiment, the luggage cart is shown with a single leg 140, which can be comprised of telescoping members. A clip 265, preferably formed of a resilient, semi-rigid polymeric material is received in close-fitting relation on leg 140. The interior surfaces of the orifice 267 are slightly tapered to facilitate the sliding of clip 265 in the direction of engagement with a case supported by the cart; conversely, the movement of the clip assembly away from the case requires a mild manual lifting force “F” to be applied to the opposing sides of the collar 269 in order to reduce the frictional drag force against the leg 140.

In the preferred embodiment shown in FIGS. 14A and 14B, the depending engagement member 266 is formed with a cutout or recess opening that can also be used to receive the end of a bungee cord or other strap when clip 265 is not being used to retain a case on the cart.

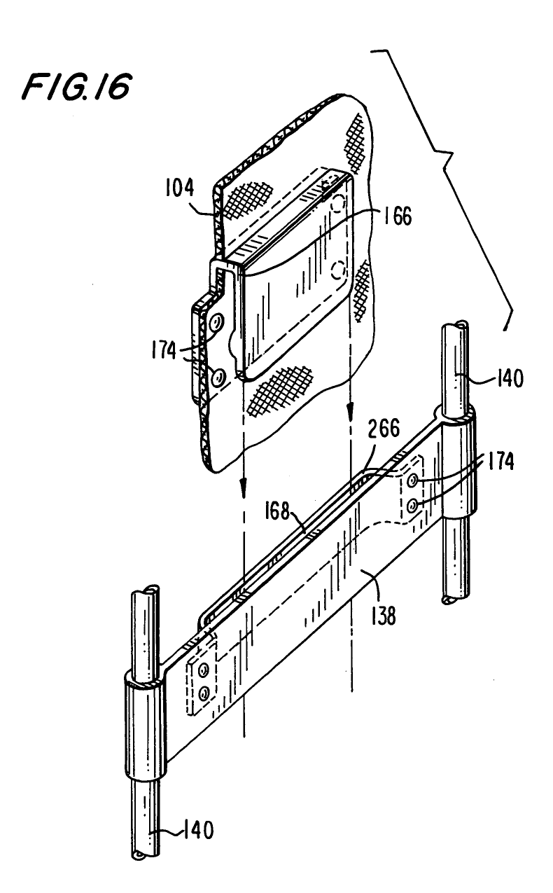

With reference to FIGS. 15A and 15B, a preferred configuration of a clip is shown, slidably mounted on a towing handle or leg 140. The lower end of the tip 263 is tapered and rounded, as best shown in FIG. 15A, and also is turned or deflected outwardly away from the leg 140, as best shown in FIG. 15B. The combination of this slight deflection, tapering, and rounded tip functions to facilitate guiding the clip 265 into the bracket (e.g., 180 in FIG. 13), which is attached to the case 102. The smooth, rounded tip contacts the wall 104 of the case above the retainer 180 and assists in sliding inwardly against the wall 104 into position behind the retaining bracket.

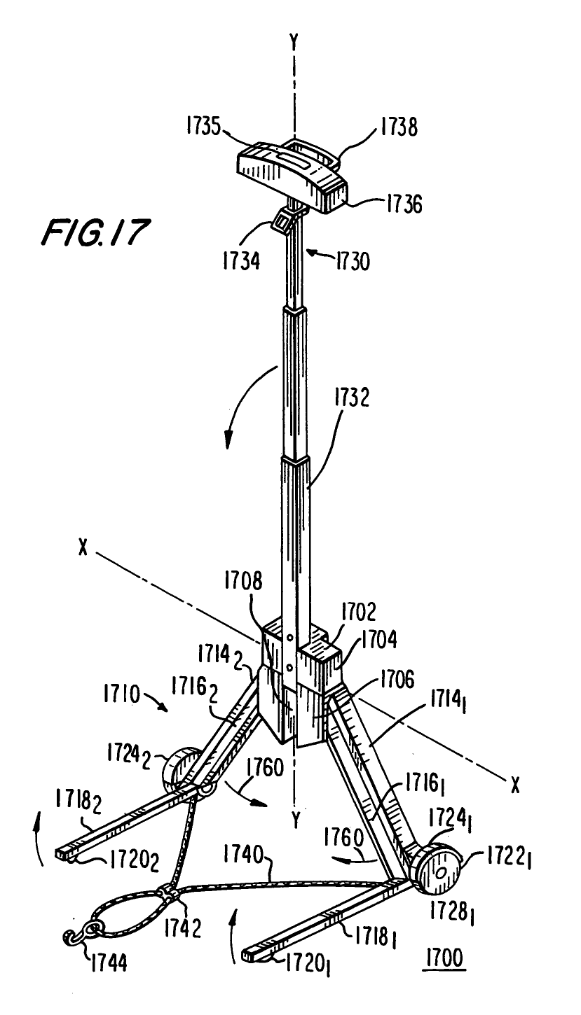

Referring now to FIG. 16, the positions of the clip and its retainer are reversed with respect to the luggage cart and carrying case. For the purposes of illustrating this embodiment, a dual leg towing handle assembly is shown, but it will be understood that a single-leg handle as shown in FIG. 3 can also be used.

With continuing reference to FIG. 16, a molded polymeric clip 166 is secured, illustratively, on the rear wall 104 of case 102 by adhesive bonding and rivets 174. A clip-retaining bracket 266 having an opening 168 for engaging the depending portion 163 of clip 166 is secured by rivets 174 to crossarm 138 that is slidably mounted on the legs 140. During use, the case is placed on the cart and clip retaining bracket 266 is moved, as needed, to securely engage the clip 166 to maintain the case on the cart by employing a slight lifting force to insure that the clip will not become disengaged over a curb, rough paving or the like.

Other means that can be used for securing the case to the luggage cart in the two alternative positions include magnetic fasteners, snaps, hook-and-loop fasteners and other devices and means conventionally known to the art.

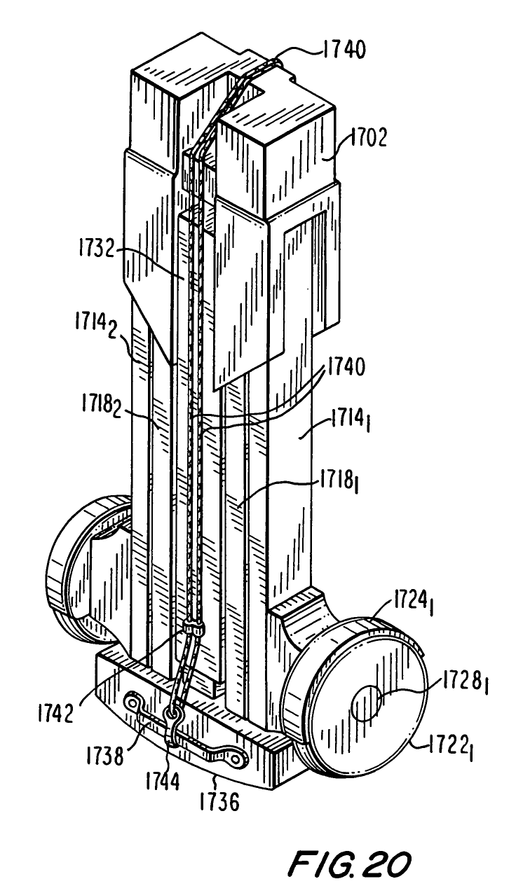

FIGS. 17-20 are various views of a compactly foldable wheeled luggage cart 1700 having a telescopic handle assembly 1712 with a clip 1736 suitable for retaining a strap 1740. FIG. 17 shows the cart 1700 in a fully open arrangement, while FIG. 20 shows the cart in a fully closed position.

The compactly foldable rolling luggage cart 1700 comprises a central housing 1702, a leg assembly 1710, and a handle assembly 1730. The central housing 1702 comprises an upper portion 1704, a lower portion 1706, and an open channel 1708 extending longitudinally along the axis Y-Y through the upper and lower portions 1704 and 1706. The open channel 1708 is formed along the front of the central housing 1702 and is sized to accommodate at least a portion of the handle assembly 1730.

The handle assembly 1730 comprises a telescoping handle 1732, a handgrip 1736, a front strap retaining member 1734, a handle locking device 1735, and a rear strap retaining member 1738. A first end of the telescoping handle 1732 is rotatably coupled within the channel 1708 of the central housing 1702. The handgrip 1736 is coupled to a second end of the telescoping handle. As shown in FIG. 17, the telescoping handle 1732 illustratively includes three sections, which allow for the extension or the retraction of the handle assembly 1730 as conventionally known in the art. The number of telescoping sections is a matter of design choice and should not be considered as being limiting.

The handle locking device 1735 is shown positioned on a top portion of the handgrip 1736 to permit the extension or retraction of the telescoping handle 1732 from the central housing 1702. In one embodiment the handle locking device 1735 is a button that can be manually depressed and released, and a person skilled in the art will appreciate that other handle locking devices and locations can be utilized to control the expansion or retraction of the handle assembly 1730.

When the telescoping handle 1732 is in a retracted position, the retracted telescoping handle 1732 can be rotated within the channel 1708 of the central housing 1702 about the transverse axis X-X shown in FIG. 17. That is, when a user wishes to fold up the cart 1700, as illustratively shown in FIG. 20, the user depresses the handle lock button 1735 to release a locking mechanism (not shown) that secures the telescoping handle 1732 in the channel 1708 of the central housing 1702 when the cart 1700 is in a fully open position.

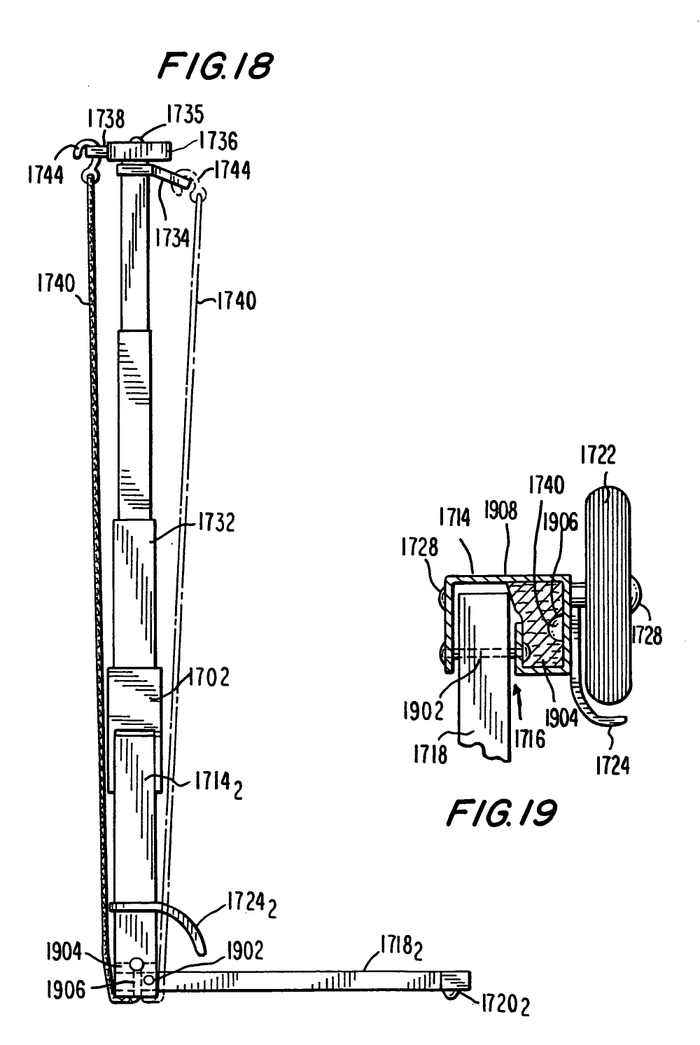

The handle assembly 1730 also includes a front strap retaining member 1734 and rear strap retaining member 1738. The front strap retaining member 1734 is conventionally coupled to an upper section of the telescoping handle 1732 proximate the hand grip 1736. The rear strap retaining member 1738 of the present invention is coupled to the hand grip 1736, for example, on the rear portion of the hand grip 1736. The front and rear strap retaining members 1734 and 1738 include a cut-out or orifice that accommodate insertion of a clip 1744 that is attached to elastic straps 1740, as discussed in further detail below with reference to FIGS. 18-20.

The leg assembly 1710 comprises a pair of retractable legs 1714₁ and 1714₂ (collectively retractable legs 1714), a pair of wheels 1722₁ and 1722₂ (collectively wheels 1722), and a pair of luggage support members 1718₁ and 1718₂ (collectively luggage support members 1718). Each retractable leg 1714 has a first end that is rotatably coupled to a side wall of the lower portion 1706 of the central housing 1702. Each retractable leg 1714 has a second end that extends a length in a direction opposite to the telescoping handle 1732 when in an open position.

At the second end of each of the retractable legs 1714 is attached a wheel 1722 and an optional wheel guard or fender 1724. Referring to FIG. 19, a bottom view of the extension leg is illustratively shown, where the wheel 1722 is attached to the extension leg 1714 via an axle 1728. The axle 1728 may be a pin, bolt, rivet or any other conventional fastener that is suitable for allowing the unimpeded rotation of the wheel 1722 thereabout.

Each retractable leg 1714 also includes a luggage support member 1718 coupled to the second end thereof. The luggage support member 1718 includes a first end that is rotatably coupled to the second end of the retractable leg 1714, such that the luggage support member may be rotated into an open channel 1716 formed in the extension leg that is sized to accommodate receiving the luggage support member 1718. Referring to the bottom view of the extension leg 1714 in FIG. 19, the luggage support member 1718 is attached in the channel 1716 via a fastener 1902 such as a rivet, bolt, pin or other conventional fasteners that accommodate rotation of the leg support member 1718 into and out of the channel 1716 of the extension leg 1714. In the embodiment shown in FIGS. 17-20, the luggage support members 1718 can be rotated in a range of approximately 0°-90° with respect to the channel 1716 and the extension leg 1714. Each luggage support member 1718 is approximately equal in length to the extension leg 1714. The channel 1716 also extends at least the length of the extension leg 1714 to accommodate receiving the luggage support member 1718 when the cart is in a folded position.

FIG. 17 illustrates the cart 1700 in an open position, where the extension legs 1714 extend obliquely with respect to a longitudinal axis Y-Y, which extends along the channel 1708 of the central housing 1702 and the extended telescoping handle 1732. When the user wishes to close the cart 1700, not only does the telescoping handle assembly 1730 retract downwards and rotate along the transverse axis 20, but the retractable legs 1714 rotate from their oblique position inwardly along a path illustrated by arrows 1760, such that the legs 1714 are parallel with one another, as illustratively shown in FIG. 20. Referring to FIG. 20, the luggage support members 1718 are shown rotated and positioned in the channel of the extension legs 1714, which are parallel with respect to each other on opposing sides of the telescopic handle 1732.

FIG. 18 is a side view of the cart 1700 illustrating the attachment of the strap assembly 1740 to the second end of the leg extension 1714. For the purpose of illustrating and understanding the invention, the wheels 1722₂ are eliminated from this side view. An elastic strap 1740, such as a bungee cord or the like, is illustratively shown in FIGS. 18 and 20 with one attached to a bottom portion of one of the extension legs, e.g., extension leg 1714₁, and the other end joined to the bottom portion of the other extension leg 1714₂.

As shown in FIG. 18, the elastic strap includes conventional a clip 1744 attached proximately mid-way between the two ends of the strap. Optionally, as shown in FIG. 20 a strap alignment clip 1742 may be provided to align at least a portion of the elastic strap substantially parallel between the clip 1744 and the strap ends, as conventionally known in the art. The elastic strap 1740 is used to help retain the luggage (not shown) in place when positioned on the luggage support base 1718 of the cart 1700. When an article of luggage is positioned on the support members 1718, the elastic strap 1740 can be stretched around the luggage and upwards towards the hand grip 1736, where the clip 1744 is fastened to the front strap retaining member 1734. Referring to FIG. 18, the elastic strap 1740 is illustratively shown (in phantom) attached to the front strap retaining member 1734 in an instance where there is no luggage presently loaded on the cart 1700.

Referring to FIG. 19, each end of the elastic strap 1740 is securely attached to the bottom portion (i.e., second end) of the extension leg 1714. In a preferred embodiment, the extension leg 1714 includes a tubular portion 1908 formed adjacent to the channel 1716 extending substantially the length of the extension leg 1714. On the bottom end of the tubular portion 1908 of the extension leg 1714 is provided an adapter or a plug 1904 that is sized to fit tightly within the tubular portion 1908. In particular, the adapter 1904 is illustratively formed from a flexible, yet resilient material, such as rubber or synthetic rubber, which is inserted or force-fitted into the bottom of the tubular portion 1908. The adapter 1904 includes a groove or orifice 1906 sized to accommodate the end of the elastic strap 1740.

Referring to FIG. 18, the end of the elastic strap 1740 is secured by the adapter 1904 against one of the interior sidewalls of the tubular portion 1908 of the retractable leg 1714. To further secure the ends of the elastic strap to the tubular portion 1908 of the retractable leg 1714, a knot (not shown) can be tied at the end of the elastic strap, such that the knot is positioned above the adapter 1904 within the tubular portion 1908.

By attaching the elastic straps 1740 to the bottom portion of each retractable leg 1714, the elastic strap 1740 can be pulled forward and around (or between) the luggage support members 1718, and up towards the handle assembly 1730 where it is fastened to the front strap retaining member 1734, via clip 1744 as illustratively shown in phantom in FIG. 18. Alternatively, the elastic strap 1740 may be pulled to the rear of the cart 1700 and pulled upward toward the handle assembly 1730 and attached to the rear strap retaining member 1738 via clip 1744.

The rear strap retaining member 1738 advantageously allows the elastic strap 1740 to be routed from the bottom portion of the extension legs 1714, and up along the rear of the handle assembly 1730, in instances where luggage is not loaded on the cart 1700 or where the use of the elastic strap 1740 to retain the luggage by clipping the elastic strap 1740 to the front strap retaining member 1734 is not required. In previously known compactable foldable rolling carts that included an elastic strap and front strap retaining member connected to the upper portion of the handle assembly, a problem was observed that when the luggage was not presently being carried by the cart, and the cart was in an open position, the elastic strap could become entangled and drag along the ground. If the strap were clipped onto the front strap retaining member, to prevent the strap from dangling and dragging, when a user collapsed the cart into its compactly folded configuration, the elastic strap 1740 usually became entangled and would have to be constantly rerouted to permit the structural member of the cart 1700 to be properly folded and collapsed. The entanglement of the elastic strap was found to be an annoyance to the user and observed to occur regardless of whether the strap was clipped to the front strap retaining member or simply left free to dangle and drag.

The present invention minimizes the undesirable entanglement problems associated with the elastic strap when the cart 1700 is folded and collapsed into its minimal structural arrangement. In particular, prior to collapsing the cart 1700 the user routes the elastic strap from the bottom portion of the retractable legs 1714 up along the rear potion of the case 1700 to the rear strap retaining member 1738. In doing so, the user stretches the elastic strap 1740 such that the clip or hook 1744 can be clipped on to the rear strap retaining member 1738. Accordingly, when the cart is in a fully opened and extended position for use, the strap 1740 is stretched to eliminate any excess slack. When the user folds and collapses the cart 1700 into its compactly folded arrangement, the locking button 1735 is depressed to (i) retract the telescoping handle 1732, (ii) rotate the telescoping handle 180° about the transverse axis X-X within the channel 1708 of the central housing 1702, (iii) push the two retractable legs from an oblique arrangement to a parallel arrangement, and (iv) fold the luggage support members 1718 into the channel 1716 of the retractable legs 1714. During this folding and collapsing operation, the elastic strap 1740 remains attached to the rear strap retaining member 1738 with minimal slack, and thereby stays out of the way during the folding and of the collapsing structural elements of the cart.

As shown in FIG. 20, the elastic strap 1740 appears coming around from the rear portion of the legs, crosses over the top of the central housing 1702 and extends down towards, and is attached to the rear strap retaining member 1738. Thus, the ability to route the elastic strap 1740 along the rear portion of the cart 1700 and fasten the clip 1744 of the strap 1740 to the rear strap retaining member 1738 eliminates, or significantly alleviates the previous entanglement problems associated with the elastic strap when folding and collapsing the cart for storage.

Accordingly, the present invention provides various embodiments of a luggage assembly 100 including a carrying case 102 and a luggage cart 130 suitable for receiving and transporting the carrying case 102 by hand. Various embodiments of the engagement member, cart, and case have been shown and described with respect to the drawings, and one of ordinary skill in the art will appreciate that the features in these embodiments can be utilized in various combinations to provide a safe, convenient and user friendly portable luggage assembly.

Although various embodiments that incorporate the teachings of the present invention have been shown and described in detail herein, those of ordinary skill in the art can readily devise other varied embodiments that incorporate these teachings that are within the scope of the claims that follow.

I claim:

1. An assembly comprising a carrying case and a rolling luggage cart, the carrying case having integral engagement means for releasably engaging the cart in at least two alternative towing positions that are displaced substantially orthogonally to each other relative to the case.

2. The assembly of claim 1, wherein the engagement means comprises a stationary member secured to a wall of the case and a rotatable member that is received for rotation in the stationary member, the rotatable member configured to retain a handle portion of the cart, whereby the cart and rotatable member are adjustable between first and second positions.

3. The assembly of claim 2, wherein the handle is slidably secured to the rotatable member.

4. The assembly of claim 2 which further includes a manually releasable locking mechanism for securing the rotatable member in a towing position.

5. The assembly of claim 2, wherein the cart comprises a base support member that includes a support plate for supporting a wall of the case during towing, the supporting plate and case having cooperative engagement means to prevent relative movement between the case and supporting plate during towing.

6. The assembly of claim 5, wherein the cooperative engagement means is selected from the group consisting of hook-and-loop fasteners, magnets, pins and recesses, and combinations thereof.

7. The assembly of claim 1, wherein the cart comprises a telescoping towing handle terminating in a handgrip, the handgrip having a stowed position below the adjacent edge of the case.

8. The assembly of claim 2, wherein the rotatable member is separable from the stationary member to thereby facilitate manual transport of the case without the cart.

9. The assembly of claim 2 in which the rotatable member is provided with intersecting grooves that receive the handle portion of the cart in close-fitting relation.

10. The assembly of claim 2, wherein the rotatable member comprises two opposing members through which the handle portion of the cart passes, the opposing members being maintained in a first position by spring-biasing means.

11. A carrying case defined by a first major dimension, a second major dimension and a minor dimension, the case having integral engagement means for receiving and releasably retaining a rolling luggage cart for supporting and manually towing the case, the engagement means configured to receive and retain the cart in a first towing position and in a second towing position, the second position being displaced approximately orthogonally from the first position.

12. The carrying case of claim 11, wherein the cart includes a handle portion and a case-supporting portion and the engagement means comprises a planar member secured exterior of a major sidewall of the case to form two intersecting channels for receiving the handle portion of the cart, whereby the case is supported for towing with either of its two major dimensions transverse to the handle portion.

13. The carrying case of claim 12, wherein the planar member is joined to the sidewall of the case at locations displaced from the channels.

14. The carrying case of claim 12, wherein the planar member is a flexible material that is secured to the sidewall.

15. The carrying case of claim 12 which has at least one carrying handle disposed on a top wall, wherein the planar member includes a recessed portion located at one end of each of the insecting channels to provide access to a towing handgrip at the end of a telescoping handle portion of the cart.

16. The carrying case of claim 14 in which one of the recessed portions is displaced inwardly from the edge of the case proximate the carrying handle of the case, whereby the handgrip is displaced below the adjacent edge of the case in a stowed position.

17. The carrying case of claim 11 which includes zipper closures for accessing the case's interior storage area, a front wall and an opposing back wall that are defined by the first and second major dimensions, the front and back walls being joined by a top wall having a carrying handle, an opposing bottom wall having a plurality of supporting feet extending from its exterior surface and a pair of opposing sidewalls, one of which optionally has a carrying handle, the case having engagement means for receiving and retaining a manually towable wheeled luggage cart having a telescoping handle terminating at one end in a handgrip and at the other end in a case supporting plate, the engagement means being permanently affixed to, or proximate to the back wall of the case, the cart cooperatively received by the engagement means in a first towing position and a second towing position displaced approximately ninety degrees from the first position, wherein the supporting plate contacts the bottom wall and the handgrip extends above the top wall in the first position and the supporting plate contacts one of the sidewalls in the second position.

18. The case of claim 17, in which the engagement means includes a clip and a clip retaining member.

19. The case of claim 17, in which the engagement means is configured to receive a handle comprising two parallel legs extending between the handgrip and the supporting plate.

20. A compactly foldable rolling luggage cart, comprising:
a central housing having an upper portion and a lower portion, and a centralized open channel extending longitudinally through the upper and lower portions;
a pair of retractable legs, each leg having a first end and a second end, the first ends coupled to and extending from opposing sides of the lower portion of the housing, each leg including a respective luggage support member rotatably coupled to and extending from the second end, a wheel respectively coupled to each second end, and each second end further including an adapter for respectively retaining an end of an elastic strap proximate the wheel;
a handle assembly comprising a telescoping extension handle having a first end rotatably coupled within the channel of the housing, and a handgrip coupled to a second end of the extension handle, the handgrip including a strap retaining member coupled to a rear portion of the handgrip, wherein the strap includes a clip coupled between the strap ends for removably attaching to the strap retaining member to mimimize excess slack in the strap when the cart is in a fully extended configuration for use and in the compactly folded configuration.
